(19) United States
(12) Patent Application Publication
(10) Pub. No.: US 2026/0028191 A1
(43) Pub. Date: Jan. 29, 2026

(54) GENERATING AND DISPLAYING ANALYTICS FOR A ROBOTIC GRIPPER

(71) Applicant: OXIPITAL AI INC., Bedford, MA (US)

(72) Inventors: Michael R. Bassett, Needham, MA (US); Jonah C. McBride, Waltham, MA (US); Jeremy Corson, Concord, NH (US); Junhua Tang, Sammamish, WA (US); David Benjamin Gibson, Needham, MA (US); Matthew Corsaro, Methuen, MA (US)

(21) Appl. No.: 19/004,999

(22) Filed: Dec. 30, 2024

Related U.S. Application Data
(60) Provisional application No. 63/675,066, filed on Jul. 24, 2024.

(51) Int. Cl. B65G 47/90; B25J 9/16

(52) U.S. Cl. CPC B65G 47/90; B25J 9/161; B25J 9/163

(57) ABSTRACT

Exemplary embodiments pertain to techniques for generating and displaying a user interface for a robotic pick-and-place system. The user interface may include, among other features, a throughput of the pick-and-place system as reflected in analytics data determined as the system attempts to effect picks. A user can adjust parameters like the opening amount of the gripper or weights applied by filter and sort rules on the interface, and monitor how changes affect throughput.

### CROSS-REFERENCE TO RELATED APPLICATIONS

This application claims the benefit of U.S. Provisional Patent Application No. 63/675,066, filed on Jul. 24, 2024, which is fully incorporated herein by reference.

### BACKGROUND

A robotic pick-and-place system is designed to enhance efficiency and precision in manufacturing, packaging, and production lines. Pick-and-place systems are generally used to pick up target objects from one location (e.g., a conveyor belt or a source container), move the target item to another location (e.g., a target container or another conveyor belt), move back towards the first location, and repeat the process.

Such a system includes several components that work in concert to perform tasks accurately and quickly. A robotic arm, sometimes referred to as a manipulator, is the central element responsible for the movement and placement of objects. Some are designed to mimic the dexterity of a human arm, allowing for a wide range of motion and the ability to handle items with care. A robotic arm can be a standalone unit mounted near a conveyor belt or other target location, may be mounted to a mobile platform, or may be mounted to a gantry or other overhead support structure (and may or may not be mobile on the support structure).

An end-effector, which can be a gripper or a vacuum system, is attached to the robotic arm and is the component that actually interacts with target objects. This part must be versatile enough to handle various shapes, sizes, and types of materials. Sensors may be integrated into the system to provide real-time data that guides the robot's actions. These can include vision systems for object recognition, force sensors for pressure adjustment, and proximity sensors for accurate positioning.

The controller is the brain of the operation, programmed with a sequence of movements that the robot follows. This programming is what allows the pick-and-place robot to execute tasks with high precision and consistency. The controller processes input from the sensors, adjusting the robot's actions as necessary to account for any variations in object placement or environmental conditions.

In some cases, the controller may be a robot controller that is configured to control the robot arm. The system may also be provided with an end-effector controller that is configured to control the end effector. In other cases, the robot controller and end-effector controller may be combined in a single controller.

Together, these components form a cohesive unit that can operate tirelessly, achieving high throughput (often measured in picks-per-minute, i.e., the number of products picked up by the robotic system in a minute) with minimal error (which may be measured as a percentage, e.g., the number of products that were successfully picked as compared to the number of picks attempted). The use of lightweight materials and high-speed motors, combined with sophisticated control algorithms, enables the system to perform rapid and precise movements, significantly improving productivity and reducing the likelihood of errors.

In the broader context of industrial automation, pick-and-place robots represent a significant advancement, offering a scalable solution that integrates well into existing workflows. Their ability to operate with consistent precision has made them indispensable in sectors such as manufacturing, logistics, and electronics assembly, where they contribute to the streamlining of processes and the reduction of labor costs.

Robotic gripper systems, while advanced, can encounter several challenges when picking up products from a moving conveyor belt. One of the primary issues is the precise identification and handling of products that are touching or overlapping. This situation can cause confusion for the system's sensors and/or controller, leading to slower picks, incorrect picks, or potential damage to the products. It is also difficult to maintain accurate real-time tracking of the products, as products may shift unpredictably due to the conveyor's motion or disturbances caused by the gripper itself.

Another problem is the variability in product size, shape, and weight, which requires the gripper to have adaptable gripping mechanisms to securely grasp different items without causing damage (e.g., because they were gripped too forcefully) and without dropping products (e.g., because they were not gripped forcefully enough).

The integration of vision systems can mitigate some of these issues by providing advanced image processing capabilities to identify and sort products effectively, even when they are clustered together. However, these systems must be finely tuned to cope with various product characteristics and environmental conditions, such as lighting and background noise. The end-of-arm tooling (EOAT) design is also important; it must be versatile enough to handle the range of products presented on the conveyor while minimizing the risk of product damage. The EOAT must work in harmony with the conveyor system, which should be engineered to present products to the gripper optimally, reducing the need for extensive movement and increasing the efficiency of the pick-and-place process.

Thus, while robotic gripper systems offer significant advantages in terms of efficiency and safety, they must be carefully designed and programmed to address the myriad of challenges presented by the dynamic environment of a moving conveyor belt.

### BRIEF SUMMARY

Exemplary embodiments relate to computer-implemented methods, as well as non-transitory computer-readable mediums storing instructions for performing the methods, apparatuses configured to perform the methods, etc.

In one aspect, a method for generating and displaying analytics for a robotic pick and place system includes displaying a user interface on a display associated with the robotic pick and place system. The user interface may include a user interface element depicting a throughput of the robotic pick and place system. The method includes executing one or more picks with the robotic pick and place system, and updating the user interface based on results of the one or more picks.

The throughput may be an instantaneous throughput at a time of one of the one or more picks, or an average throughput over a predetermined time interval.

The interface may further include a user interface element depicting a score output by one or more of filtering or sorting logic configured to provide information used to select a next pick for the pick and place station.

The interface may further include a user interface element depicting a number or a percent of missed picks over a predetermined time interval, a user interface element depicting a number or a percent of missed placements over a predetermined time interval, a user interface element depicting a grasp quality achieved by the pick and place system, a user interface element depicting an overall equipment effectiveness value for the pick and place system, and/or a user interface element depicting an object segmentation for objects picked in the one or more picks. In the latter case, the object segmentation may furthermore depict at least one of an orientation or a size of the object

Other technical features may be readily apparent to one skilled in the art from the following figures, descriptions, and claims.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 is a cross sectional side view of a soft robotic gripper suitable for use with exemplary embodiments.

FIG. 2A is a perspective view of an assembled soft robotic gripper including a mounting assembly for mounting the gripper to a robotic arm or end-of-arm tool suitable for use with exemplary embodiments.

FIG. 2B is a perspective exploded view of the soft robotic gripper of FIG. 2A.

FIG. 3 depicts an example of a robotic gripper attached to a robotic arm and controller, which may be an end effector controller or a general controller configured to control both the end effector and the robotic arm, suitable for use with exemplary embodiments.

FIG. 4 depicts a robotic pick-and-place system suitable for use with exemplary embodiments.

FIG. 5 depicts a robotic pick-and-place system suitable for use with exemplary embodiments.

FIG. 6 depicts hardware and control logic suitable for use in an exemplary robotic pick-and-place system.

FIG. 7 illustrates exemplary aspects of machine learning logic suitable for use with a robotic pick-and-place system.

FIG. 8 is a flowchart depicting exemplary logic for performing a computer-implemented method according to an exemplary embodiment.

FIG. 9 is a flowchart depicting exemplary logic for collecting and using analytics for a pick-and-place system according to an exemplary embodiment.

FIG. 10 depicts an exemplary analytics user interface in accordance with one embodiment.

FIG. 11 depicts an exemplary analytics user interface in accordance with one embodiment.

FIG. 12 is a flowchart depicting exemplary logic for performing a computer-implemented method according to an exemplary embodiment.

FIG. 13 depicts an illustrative computer system architecture that may be used to practice exemplary embodiments described herein.

### DETAILED DESCRIPTION

In robotic pick-and-place systems (and other similar systems employing robotic arms to move target objects from one location to another), one or more robotic arms may effect “picks” of target objects at or near designated locations, referred to as source locations. The objects to be grasped may be moved to the source locations, for example, on a conveyor belt and/or in a bin. The objects may be highly disorganized-they may be presented to the source locations in chaotic piles, with some objects touching or overlapping others.

In many pick-and-place systems, several robotic arms work in concert to pick up objects from the pile and move them to a destination location. If a robotic arm at a first location does not pick up one of the target objects in a first pick, then that robotic arm might return to the target object in a second pick (assuming that the target object remains in a source location accessible to the robotic arm), or might allow the target object to move down the line to a second source location served by a second robotic arm, which might pick up the target product.

Coordinating such a system can be difficult. Typically, each robotic arm needs to be informed (typically by a controller) which of the many available target objects the arm should attempt to grasp for the current pick. To that end, a sensor (such as a camera) may be employed upstream of the robotic arms. The sensor may capture an image of the piles of product as they move towards the source locations, and may assign a particular target identified in the image to each robotic arm. Because the image processing involved in this determination is very complicated (and must be repeated as more product moves into the sensor's field of view), conventional systems often perform this processing only once as the product moves towards the robotic arm(s). However, some of the objects can easily shift as they move down the line-either on their own, due to the motion of the conveyor belt, or because they are overlapping with or touching another object that the robotic arm attempts to pick up. As the other object is moved, it may strike one or more nearby objects, causing them to be moved as well. Accordingly, by the time a particular object makes its way through the source locations of one or more robotic arms, the pile may look entirely different than it did when it was first imaged by the sensor. Still further, objects may be actively in motion as a grasp attempt is made (making it more difficult for the robotic arm to accurately grasp the moving object).

Consequently, robotic arms located further down the line will often attempt to grasp a target that is no longer at the location where it is expected to be, resulting in missed grasps. This reduces the overall efficiency of the pick-and-place system.

Exemplary embodiments described herein provide solutions to these and other problems. Although it is contemplated that the various improvements described herein may be used separately to improve pick-and-place accuracy and efficiency, it is also contemplated that they may be used in various combinations, such as a system employing each of the described improvements in robotic vision and object discrimination, machine learning, rules and filters for selecting a pick target, grasp detection and analytics, and coordination between a robotic vision system/controller and robotic arm. These improvements may be used in any suitable combination.

Using these features together, the present inventors have tested pick-and-place systems that were capable of effecting 90 or more picks per minute with 99.7% pick efficacy. At a very high level, the described solution performs processing tasks that are more intensive, such as object discrimination, at an upstream sensor that images a chaotic pile of products before the products arrive at downstream robotic stations. The system then coordinates with the downstream robotic stations to effect picks re-image the pile as the robot's picks make changes to the pile. The system performs less intensive processing in real-time to track the objects that were identified at the upstream sensor as they move past the robotic picking stations.

The robotic arms and associated downstream sensors work together to re-image the pile as the robotic arms move out of the field of view of the downstream sensors. In the amount of time that it takes for the robotic arm to pick up an object, move the object to a destination location, and return to the source location (typically on the order of a few hundred milliseconds), several coordinated actions have occurred. In addition to re-imaging the pile with the downstream sensor, the controller tracks objects that have moved and applies filters and rules that identify the next target object to be picked. The robotic arm then attempts a pick of this next target object, and the process repeats. In some embodiments in which multiple robotic systems are arranged (e.g., in series so that a subsequent robotic arm attempts to pick up objects that are not picked up by an upstream prior robotic arm), different robotic arms may be provided with different rules and filters to provide load balancing capability.

The object discrimination and tracking are made more effective and efficient using one or more machine learning constructs that perform segmentation, classification, pose determination, and occlusion determination. In some embodiments, the models are multiheaded so that several pieces of information can be returned for use by the filters and rules very quickly. The machine learning constructs are trained using a large amount of uniquely generated, synthetic training data. These synthetic assets may have multiple parts, allowing for more variation in the training data and better identification of specific aspects of the objects (e.g., if the target objects are pieces of chicken, the amount of fat remaining on pieces of chicken can be varied on the assets and thus the system can be trained to better discriminate between target objects of varying grades or qualities). A calibration process may be used so that the training data is presented at a calibrated level of light, color, brightness, exposure, etc. The conditions in the environment around the robot can then be brought into conformity with these calibrated levels to improve performance of the robot. Still further, synthetic distractors (non-target objects, different textures, conveyor belt mechanisms) can be added to the training data to improve performance.

As the robotic system attempts various picks of the target objects, some objects may be missed or not grasped optimally. Exemplary embodiments provide hardware and logical solutions for detecting the quality of a grasp (and/or when a grasp has been missed). As grasps are attempted, the grasp quality may be logged alongside other analytics, such as the pose and amount of occlusion identified by the machine learning constructs, the parameters used by the filters and rules to select the next target object to be grasped, etc. An analytics interface may be presented that shows the information that was used in the decision-making for selecting a particular object to be grasped, as well as whether the grasp was successful. A user of the system may make changes (e.g., to the parameters used in the rules and filters) in order to change which target objects are being selected—for example, the user can make the system more or less aggressive in terms of picking up targets that are partially occluded. The system may also display overall analytics, such as pick efficacy over a period of time, so that the user or the system can determine if changes to the rules and filters result in better or worse overall throughput. Thus, the system can be adjusted in real-time in order to improve its performance.

### A Note on Data Privacy

Some embodiments described herein make use of training data or metrics that may include information voluntarily provided by one or more users. In such embodiments, data privacy may be protected in a number of ways.

For example, the user may be required to opt in to any data collection before user data is collected or used. The user may also be provided with the opportunity to opt out of any data collection. Before opting in to data collection, the user may be provided with a description of the ways in which the data will be used, how long the data will be retained, and the safeguards that are in place to protect the data from disclosure.

Any information identifying the user from which the data was collected may be purged or disassociated from the data. In the event that any identifying information needs to be retained (e.g., to meet regulatory requirements), the user may be informed of the collection of the identifying information, the uses that will be made of the identifying information, and the amount of time that the identifying information will be retained. Information specifically identifying the user may be removed and may be replaced with, for example, a generic identification number or other non-specific form of identification.

Once collected, the data may be stored in a secure data storage location that includes safeguards to prevent unauthorized access to the data. The data may be stored in an encrypted format. Identifying information and/or non-identifying information may be purged from the data storage after a predetermined period of time.

Although particular privacy protection techniques are described herein for purposes of illustration, one of ordinary skill in the art will recognize that privacy protected in other manners as well. Further details regarding data privacy are discussed below in the section describing network embodiments.

Assuming a user's privacy conditions are met, exemplary embodiments may be deployed in a wide variety of messaging systems, including messaging in a social network or on a mobile device (e.g., through a messaging client application or via short message service), among other possibilities. An overview of exemplary logic and processes for engaging in synchronous video conversation in a messaging system is next provided.

### Exemplary Embodiments

As an aid to understanding, a series of examples will first be presented before detailed descriptions of the underlying implementations are described. It is noted that these examples are intended to be illustrative only and that the present invention is not limited to the embodiments shown.

Reference is now made to the drawings, wherein like reference numerals are used to refer to like elements throughout. In the following description, for purposes of explanation, numerous specific details are set forth in order to provide a thorough understanding thereof. However, the novel embodiments can be practiced without these specific details. In other instances, well known structures and devices are shown in block diagram form in order to facilitate a description thereof. The intention is to cover all modifications, equivalents, and alternatives consistent with the claimed subject matter.

In the Figures and the accompanying description, the designations “a” and “b” and “c” (and similar designators) are intended to be variables representing any positive integer. Thus, for example, if an implementation sets a value for a=5, then a complete set of components 122 illustrated as components 122-1 through 122-a may include components 122-1, 122-2, 122-3, 122-4, and 122-5. The embodiments are not limited in this context.

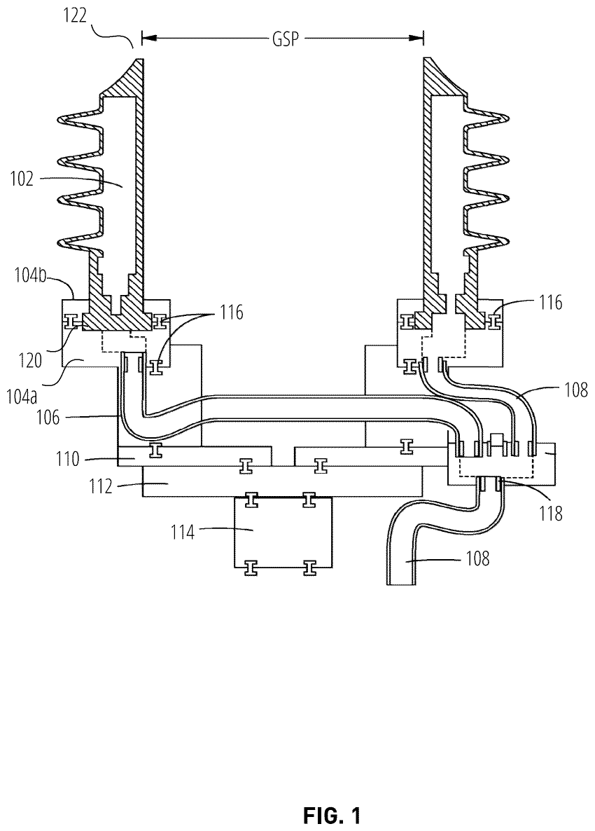

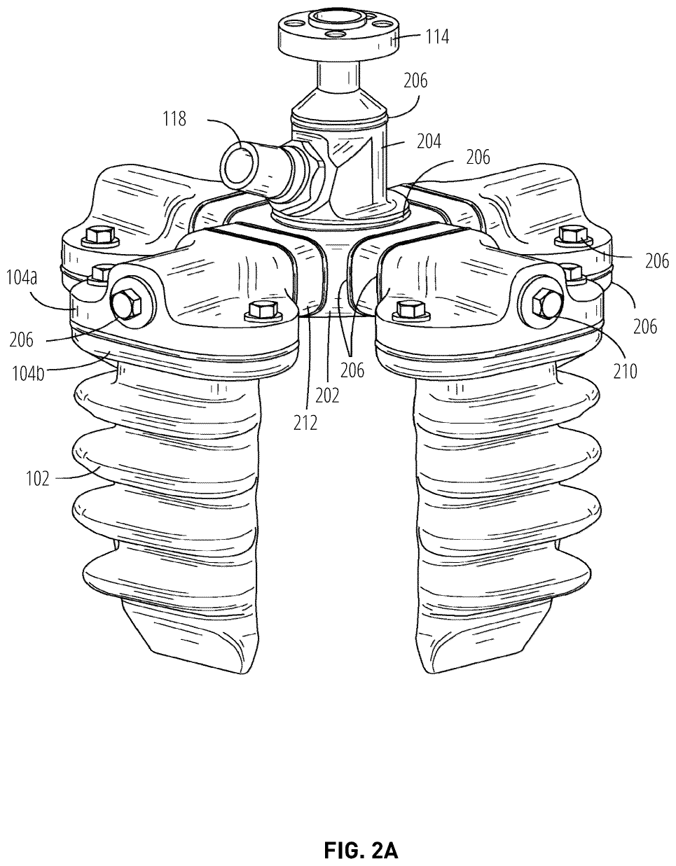

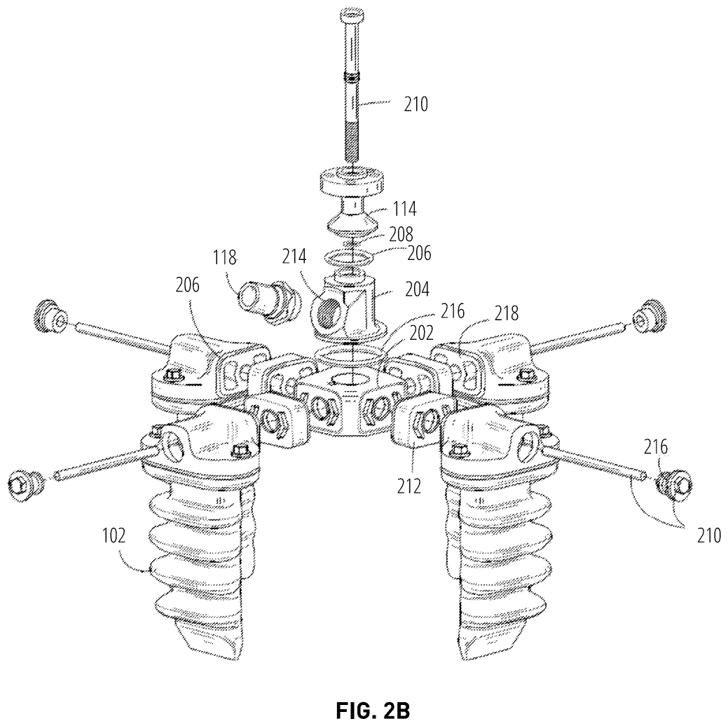

FIG. 1-FIG. 2B depict examples of soft robotic grippers. Although exemplary embodiments are described in connection with soft or inflatable fingers or grippers, the present invention is not so limited. One of ordinary skill in the art will understand that the improvements and techniques described herein may also be employed with hard fingers or grippers, and/or hybrid fingers or grippers employing a mix of hard and soft components.

Soft or inflatable fingers or grippers may move in a variety of ways. For example, inflatable fingers may bend, or may twist, as in the example of the soft tentacle (“actuator”) described in U.S. patent application Ser. No. 14/480,106, entitled “Flexible Robotic Actuators” and filed on Sep. 8, 2014. In another example, soft or inflatable fingers may be linear actuators, as described in U.S. patent application Ser. No. 14/801,961, entitled “Soft Actuators and Soft Actuating Devices” and filed on Jul. 17, 2015. Still further, soft or inflatable fingers may be formed of sheet materials, as in U.S. patent application Ser. No. 14/329,606, entitled “Flexible Robotic Actuators” and filed on Jul. 11, 2014. In yet another example, soft or inflatable fingers may be made up of composites with embedded fiber structures to form complex shapes, as in U.S. patent application Ser. No. 14/467,758, entitled “Apparatus, System, and Method for Providing Fabric Elastomer Composites as Pneumatic Actuators” and filed on Aug. 25, 2014. One of ordinary skill in the art will recognize that other configurations and designs of soft or inflatable fingers are also possible and may be employed with exemplary embodiments described herein.

### Configurable Soft Grippers

As shown in FIG. 1, soft robotic members 102 may be used together with T-shaped modular rail systems, with the provision of a finger mount or interface that allows two or more soft robotic members 102 to be arranged into a tool using combinations of T-shaped rails and T-shape rail accessories. The interface may include a robot-side interface 104a and an actuator-side interface 104b and may be made of a food- or medically-safe material, such as stainless steel, polyethylene, polypropylene, polycarbonate, polyetheretherketone, acrylonitrile-butadiene-styrene (“ABS”), or acetal homopolymer. As an alternative or in addition to a T-shaped rail, the soft robotic member 102 may be mounted directly to a robot through a suitable adapter or interface.

A soft robotic gripper may include one or more soft robotic members 102, which may take on organic prehensile roles of a finger, arm, tail, or trunk, depending on the length and actuation approach. The present disclosure tends to use “finger” to describe the soft robotic members 102, but any bendable soft robotic member may be used in place of a finger. In the case of inflating and/or deflating soft robotic members 102, two or more members may extend from a hub mounting flange 112, 202, and the hub mounting flange 112, 202 may include a manifold for distributing fluid (gas or liquid) to the soft robotic members 102 and/or a plenum for stabilizing fluid pressure to the manifold and/or gripper members. The soft robotic members 102 may be arranged like a hand, such that the soft robotic members act, when curled, as digits facing, a “palm” mounting flange 112, 202 against which objects are held by the soft robotic members 102. Alternatively or in addition, the soft robotic members 102 may be arranged like an cephalopod, such that the soft robotic members 102 act as arms surrounding an additional central hub actuator or sub-effector (suction, gripping, or the like).

As shown in FIG. 1-FIG. 2B, a soft robotic member 102 may extend from a proximal end 120 to a distal end 122. The proximal end 120 may connect to a finger mount or interface 104a, 104b. The interface 104a, 104b may be made of a hygienic or food contact material, such as polyethylene, polypropylene, polycarbonate, polyetheretherketone, acrylonitrile-butadiene-styrene (“ABS”), or acetal homopolymer. The interface 104a, 104b may be releasably coupled to one or both of the soft robotic member 102 and/or mount 106, e.g., via a pneumatic coupling 118. The mount 106 houses and directs air to and from the soft robotic member 102 via a port in the soft robotic member 102. Different finger mounts 106 may have different sizes, numbers, or configurations of soft robotic member 102.

A soft robotic member 102 may be inflated with an inflation fluid, pneumatic or other, from an inflation device through flexible tubing 108. Where pneumatic inflation/deflation is discussed herein, except where constraints particular to pneumatic operation are inherent or expressly discussed, other fluids may be used. The interface 104a, 104b may include or may be attached to a valve for allowing air to enter the soft robotic member 102 but preventing air from exiting the soft robotic member 102 (unless the valve is opened). The flexible tubing 108 may also or alternatively attach to an inflator valve at the inflation device or controller for regulating the supply of air and/or vacuum at the location of the inflation device.

FIG. 1 depicts a side-view of a system in which two soft robotic members 102 are mounted to a rail 110 to form a robotic gripper. In this example, the soft robotic members 102 are held to a length of the rail system using the mount 106, employing fasteners 116 (e.g., bolts). The soft robotic members 102 can slide along the rails 110 to decrease the gripping span (GSP) between the soft robotic members 102. For example, the fasteners 116 of the mounts 106 may be loosened to allow the soft robotic members 102 to slide along the rails 110, which allows the end-effector to be configured for objects of different sizes with the same device. The mounts 106 may provide a sealed pneumatic inlet (e.g., quick change or ferrule) for pressurizing and depressurizing the soft robotic members 102 via the flexible tubing 108.

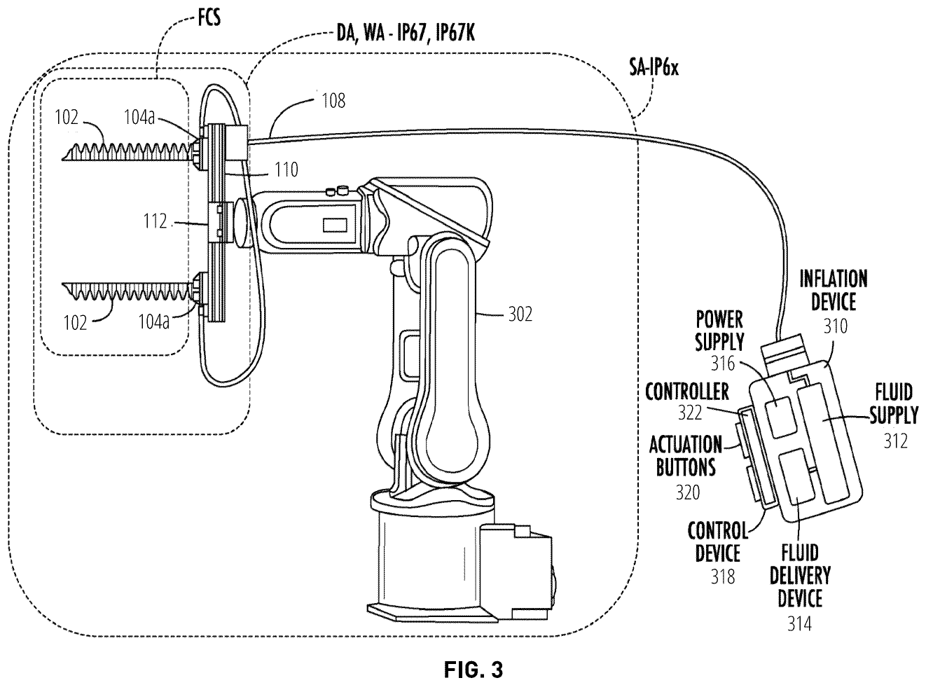

An assembled effector may be secured to an industrial or collaborative robot (e.g., robotic arm 302, see FIG. 3) via a mounting flange 112 on the rail 110 in order to enable the robot to pick and place objects of interest. The mounting flange 112 on the rail 110 may be configured to mate with a corresponding flange on the robotic arm to secure the end effector system to the robotic arm. An adapter 114 may be used to interface between the mounting flange 112 and different manufacturers' robot arm mounts. A pneumatic passage may be provided through the mounting flange 112 to allow an inflation fluid to pass from the robotic arm through the mounting flange 112, through the rail 110 and into the soft robotic members 102. It should be noted that this style of adjustable gripper is not limited to the use of T-slot extrusion; other modular rail mounting systems may provide similar functionality.

FIG. 1 depicts individual soft robotic members 102 that are relocatable, but the same principle may be applied to groups of soft robotic members 102 that are movable with respect to each other. For example, the individual soft robotic members 102 of FIG. 1 could be replaced with groups of soft robotic members 102 forming gripping mechanisms. The movement of the soft robotic members 102 along the rail 110 (or other guidance mechanism) may be achieved manually (e.g., using adjustable components that are moved by an operator) or automatically (e.g., using a motor, pneumatic feed, or other device suitable for effecting movement of the soft robotic members 102).

The soft robotic members 102 or grippers in this array may be driven in that the position of a soft robotic member 102 or a gripper can be changed via the action of a machine. For example, the soft robotic members 102 may be driven via a motor that drives a screw or belt that is attached to the soft robotic members 102, or by a pneumatically-actuated piston that is attached to the soft robotic member 102 or gripper.

Accordingly, T-slot extrusion may be used to create grippers for which the soft robotic members 102 can be reconfigured in one dimension, in two dimensions, and in three dimensions. The systems shown in FIG. 1 are perhaps most useful for prototyping, which is consistent with the general utility of T-shaped rails. In production environments, successful solutions may be more constrained. For example, production solutions must generally be more lightweight so that the gripper weight is a smaller proportion of the entire tool payload, can be moved/spun at high speed especially between picks, and/or are microbially ingress sealed and/or washable or sprayable.

FIG. 2A and FIG. 2B show perspective views of a soft robotic gripper that includes provisions for lower weight, less mass toward the perimeter, and is structured for food contact sealing and other requirements. The soft robotic gripper includes component parts capable of being assembled in the field at the terminus of an industrial robot arm (e.g., the robotic arm 302 depicted in FIG. 3) for providing adaptive gripping of an object, such as a food product. FIG. 2A is a perspective view of a field-assembled soft robotic gripper, and FIG. 2B is an exploded perspective view of the field-assembled soft robotic gripper of FIG. 2A, with like-numbered elements and similarly located and configured elements sharing the description of FIG. 2A.

The soft robotic gripper includes an upper hub mount 204, which may be split into an upper hub and a lower hub. The upper hub mount 204 is capable of mounting to the terminus of a robotic arm, and includes a pneumatic inlet 214 formed therethrough. The pneumatic inlet 214 leads to one or more (e.g., radial) outlets for supplying inflation fluid to the soft robotic members 102, and a tension fastener 210 adjacent one or more radial outlets. The tension fastener 210 may be, for example, a machine screw bolt or threaded rod, or another anchoring mechanism (a quick-connect, detent, set-screw, loop or hook, bayonet mount, or other mechanical anchor).

The upper hub mount 204 is surrounded by a hub 202, having a plenum clearance or cavity formed therein, capable of forming a plenum chamber (in this example an annular one) between the radial outlets of the upper hub mount 204 and the hub 202. The hub 202 includes a manifold of (e.g., radial) channels formed therein, capable of facing respective fastener anchors when the plenum chamber is formed (by, e.g., inserting the upper hub mount 204 into the hub 202 with the plenum clearance therebetween).

As shown, the gripper system includes a plurality of soft robotic members 102. Each soft robotic member 102 may be formed as or including an elastomer body which bends under inflation in a first direction (e.g., curling in, in a grasping direction) and, in an ambient air environment, under vacuum in a second direction (e.g., curling out, in a release direction), and a fluid port capable of providing pneumatic inflation and deflation (e.g., when the gripper is assembled at the terminus of a robotic arm, with an inflation device connected to the pneumatic inlet 214 of the upper hub mount 204). The fluid port may be equal to or smaller in cross sectional area than the channels, the plenum chamber, and/or the pneumatic inlet 214 and/or flexible tubing 108.

Each soft robotic member 102 is housed and sealed within interfaces 104a, 104b, with a rim of the soft robotic member 102 being compressible as a pneumatic and/or microbial ingress seal. Accordingly, two or more interfaces 104a, 104b each include a pneumatic passage capable of connecting a respective radial channel of the palm to a respective soft robotic member 102 (and inflatable via the plenum chamber and hub outlet(s)).

Each of the interfaces 104a, 104b may be held in compression to the hub 202 by a tension fastener 210. Each tension fastener 210 is capable of securing a respective interface 104a, 104b to the hub 202 (and/or upper hub mount 204) by passing through a respective pneumatic passage, channel and the plenum chamber and fastening under tension to the fastener anchor. As shown, inserted pneumatic seals 208, microbial ingress seals 206, and/or dual-function seals 216 are thereby compressed between the interfaces 104a, 104b and hub 202. In some configurations, a tension fastener 210 may extend between two robot-side interfaces 104a (passing through the upper hub mount 204, and/or a hub 202 to a tension anchor/nut on an opposite side of the upper hub mount 204), and inserted pneumatic, microbial ingress, and/or dual-function seals 206, 208, 216 may be compressed between the robot-side interfaces 104a and upper hub mount 204. In order to allow the gripper to be configured based on the intended application, one or more spacers 212 may be provided at various locations on the gripper, as shown.

Optionally, the upper hub mount 204 is formed from a metal material, such as stainless steel or aluminum, and the palm and finger mounts have a volumetric mass density less than ½ that of the robot interface of metal material. Almost all plastics and polymers have a volumetric mass density less than ½ of metals, and composites, honeycomb, hollow and/or foamed metals may also have a (averaged) volumetric mass density below substantially ½ of that of the hub material. This dense/strong center, less dense perimeter approach permits overall lower mass, higher gripping payloads (heavier gripped objects) and higher translation acceleration, as well as higher angular accelerations, as the peripheral mass and moment of inertia are significantly lower.

The gripper may use first pneumatic seals 208, such as pneumatic O-rings, capable of insertion surrounding each matched radial channel and pneumatic passage between the hub 202 and each interface 104a, 104b. These seals or O-rings are compressed to maintain air and vacuum pressure. However, pneumatic seals that are not at an exterior surface of the gripper cannot prevent ingress of fluids and microbes at those surfaces. Accordingly, optionally, the gripper may also include first microbial ingress seals 206 capable of insertion surrounding the pneumatic seals 208 (e.g., in substantially a same plane), at each interface where an outer surface of the hub 202 meets an outer surface of each respective interface 104a, 104b (or, for example, where spacers 212 meet any of the hub 202, robot-side interface 104a, actuator-side interface 104b, or upper hub mount 204). The microbial ingress seals 206 may be substantially in-plane with and/or parallel with the pneumatic seals 208, and compressed by the same tension fasteners as the pneumatic seals 208. In some cases, a “dual function’ seal or O-ring may be located to provide both pneumatic scaling and fluid ingress sealing, when the necessary location of the fluid ingress seal at the outer surface is also suitable as a pneumatic seal. In other cases, a dual function gasket may extend from the pneumatic sealing location to the ingress sealing location, in the same plane as each seal. The seals depicted throughout the several Figures are not shown in every location necessary or advantageous for food contact/ingress protection sealing or pneumatic sealing, but in exemplary locations. Locations include: at each common mechanical interface (e.g., between a hub abutting a spacer, a hub abutting a finger mount, a hub abutting a cap; a palm abutting a spacer, a palm abutting a finger mount, a palm abutting a cap a spacer abutting a finger mount, a spacer abutting another spacer or an adapter); between upper hub and palm, between lower hub and palm, between upper hub and arm interface. As used “abutting” does not exclude the engagement of the common mechanical interfaces via the male/female plugs.

Optionally, the upper hub mount 204 is formed as a lower hub including the (one or more, e.g., radial) outlets and the (one or more) fastener anchors, and an upper hub including the pneumatic inlet 214, wherein the lower hub and upper hub are capable of sandwiching the hub 202 therebetween (e.g., in compression, held by a tension fastener, to compress/seal pneumatic seals 208, microbial ingress seals 206, and dual-function seals 216) to couple or connect the air path between the radial outlets and the pneumatic inlet 214, each of the upper hub and lower hub capable of sealing to the hub 202. As shown in the several Figures, the pneumatic inlet 214 is schematically depicted as a straight path with 90 degree corners, but the pneumatic inlet 214 may be angularly merged into the path of a channel along the length of the upper hub. Pneumatic seals or O-rings may also or alternatively be arranged in concentric locations, sealing between a cylindrical perimeter of the upper or lower hub and a cylindrical inner wall of the hub 202.

Optionally, the soft robotic gripper may also include second pneumatic seals 208 capable of insertion surrounding each of the upper and lower hubs and capable of pneumatically sealing the upper hub and lower hub to the hub 202, and/or second microbial ingress seals 206 capable of insertion at each interface where an outer surface of the hub 202 meets an outer surface of each of the respective upper hub and lower hub.

Further optionally, the fastener anchors may each include a tapped hole formed in the upper hub mount 204, and the tension fasteners 210 may each include an elongated member having machine screw threads, mating to a respective tapped hole. The elongated member may be a partially or entirely threaded rod, or may be a bolt.

Still further optionally, product contact areas of the soft robotic member 102 may be as smooth or smoother than substantially 32 microinch average roughness (Ra) and non product contact areas of the gripper may be as smooth or smoother than substantially than approximately 125 microinch (Ra). These are suitable for food contact or adjacent areas of function.

As shown in FIG. 3, an assembled effector may be secured to an industrial or collaborative robot (e.g., robotic arm) 302 via a mounting flange 112 on the rail 110 in order to enable the robotic arm 302 to pick and place objects of interest. The mounting flange 112 on the rail 110 may be configured to mate with a corresponding flange on the robotic arm 302 to secure the end effector system to the robotic arm 302. An adapter 114 may be used to interface between the mounting flange 112 and different manufacturers' robotic arm 302 mounts. A pneumatic passage may be provided through the mounting flange 112 to allow an inflation fluid to pass from the robotic arm 302 through the mounting flange 112, through the rail 110 and into the soft robotic members 102. It should be noted that this style of adjustable gripper is not limited to the use of T-slot extrusion; other modular rail mounting systems may provide similar functionality.

FIG. 3 depicts a particular example in which an end effector is deployed on a robotic arm 302, but in some embodiments the soft robotic members 102 may be deployed on a gantry or other mechanism. The robotic arm 302 itself may be mounted to a suitable surface, such as the floor, a pedestal, or an overhead gantry system. In some embodiments, the robotic arm 302 may be mobile (e.g., it may be attached to a mobile mount on a gantry system, where the mobile mount is able to translate or rotate the robotic arm 302 in one or more directions).

An inflation device 310 may include a fluid supply 312, which may be a reservoir for storing compressed air, liquefied or compressed carbon dioxide, liquefied or compressed nitrogen or saline, or may be a vent for supplying ambient air to the flexible tubing 108. The inflation device 310 may further include a fluid delivery device 314, such as a pump or compressor, for supplying inflation fluid from the fluid supply 312 to the soft robotic member 102 through the flexible tubing 108. The fluid delivery device 314 may be capable of supplying fluid to the soft robotic member 102 or withdrawing the fluid from the soft robotic member 102. The fluid delivery device 314 may be powered by electricity provided by a power supply 316.

The inflation device 310 depicted in FIG. 3 is intended as a high-level example only. Depending on the application, different types of inflation devices 310 may be used. The inflation device 310 may include appropriate components, such as end effector and/or general purpose controllers, fluid control valves, a power input (e.g., a 24V DC input), data signal inputs and/or outputs (e.g., to/from the robotic arm 302 and/or the end effector).

The power supply 316 may also supply power to a control device 318. The control device 318 may allow a user or programmed routine to control the inflation or deflation of the actuator, e.g. through one or more actuation buttons 320 (or alternative devices, such as a switch), or via executable code stored in memory or otherwise transmitted to or made accessible by control device 318. The control device 318 may include a controller 322 for sending a control signal to the fluid delivery device 314 to cause the fluid delivery device 314 to supply inflation fluid to, or withdraw inflation fluid from, the soft robotic member 102.

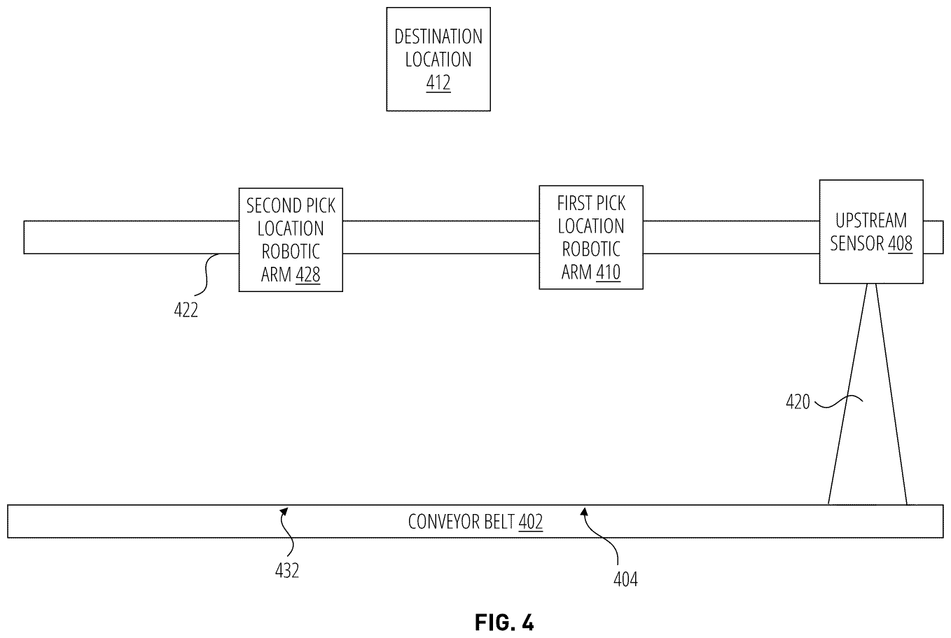

FIG. 4 depicts an exemplary environment in which one or more robotic arms, such as the robotic arms 302 discussed above, may be deployed. FIG. 4 is specifically directed to a pick-and-place system utilizing an upstream sensor 408 to image incoming objects to be picked up by a first pick location robotic arm 410 and/or second pick location robotic arm 428.

The environment includes a conveyor belt 402 for moving objects to pick locations, including a first pick location 404 that is serviced by a first pick location robotic arm 410 and a second pick location 432 that is serviced by a second pick location robotic arm 428.

An upstream sensor 408 (e.g., a camera) images the objects before they move to the first pick location 404. The upstream sensor 408 has a field of view 420. The objects are imaged as they move into the field of view 420. At this point, a controller may examine images produced by the upstream sensor 408 and create a plan for picking the target objects using the first pick location robotic arm 410 and/or second pick location robotic arm 428 as they are projected to move into the first pick location 404 and second pick location 432.

Problematically, the field of view 420 covers only an area upstream of the first pick location 404 and second pick location 432. The objects are not re-imaged as they move into the first pick location 404 and second pick location 432. Typically, the objects will be arranged in a haphazard or chaotic pile, with objects mixed together, some objects partially or entirely obscuring other objects, etc. Some objects may be in motion at the time they enter the field of view 420.

Accordingly, when a picking plan is developed by the controller on the basis of the imagery provided by the upstream sensor 408, it may not account for objects that are obscured. Meanwhile, objects that are in motion at the time the are imaged by the upstream sensor 408 may not be present in the same location (e.g., relative to other objects) by the time they arrive at the first pick location 404 and/or second pick location 432. Similarly, when the first pick location robotic arm 410 attempts to pick up an object that is touching or overlapping with another object, the action of the first pick location robotic arm 410 in picking up the object may cause other objects to move. Accordingly, when the first pick location robotic arm 410 (or the second pick location robotic arm 428) attempts to perform subsequent picks, the object that the arm is attempting to pick up may no longer be present at the expected location. These factors can cause picks to be missed, lowering the efficiency of the system.

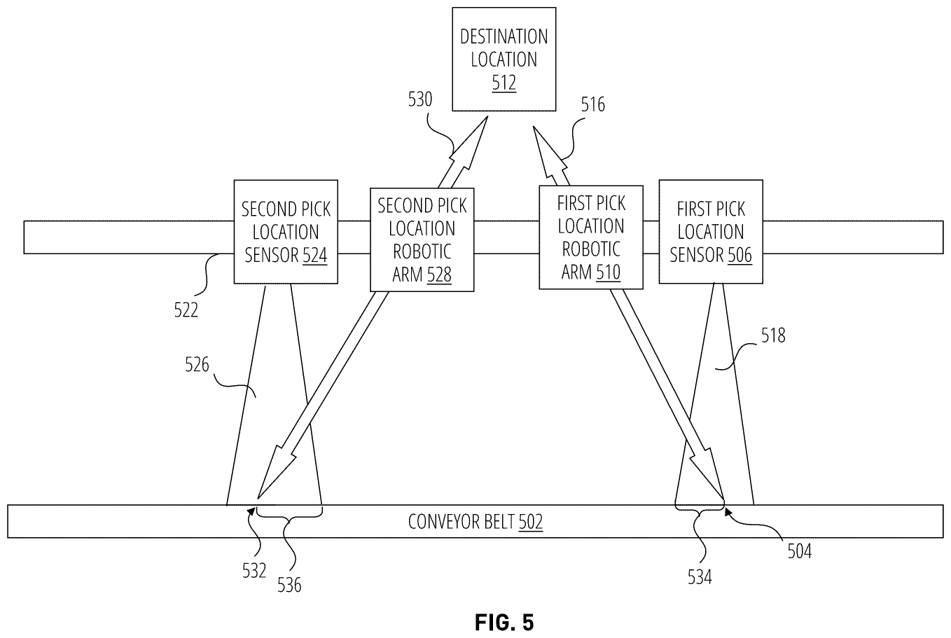

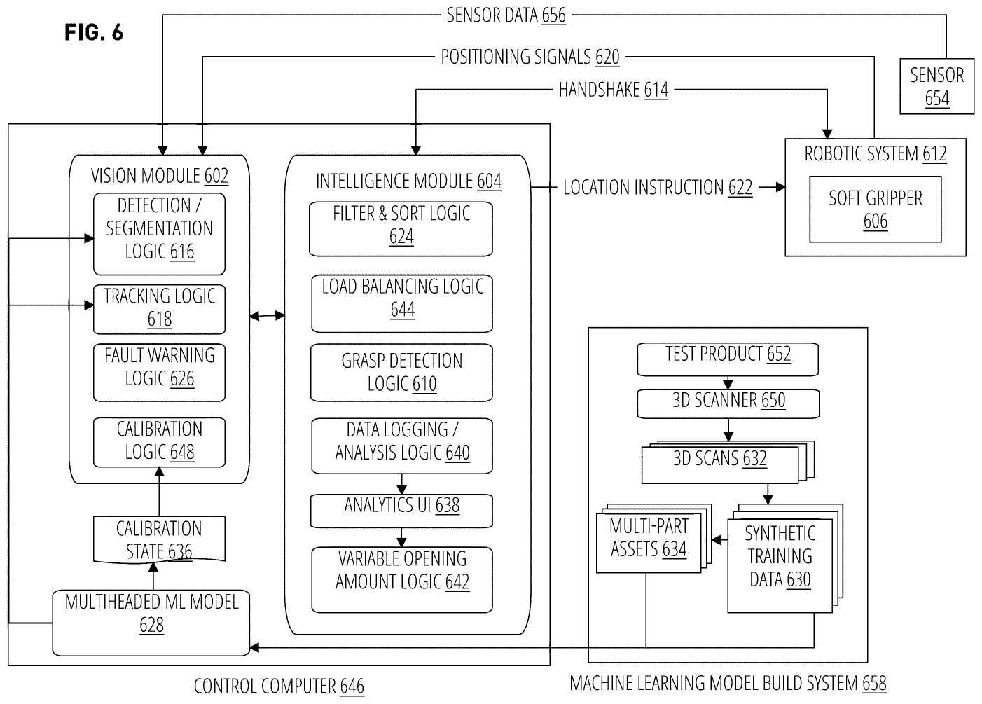

To address these and other issues, FIG. 5 depicts an exemplary environment in which one or more robotic arms, such as the robotic arms 302 discussed above, may be deployed. FIG. 6, which will be discussed in conjunction with FIG. 5, depicts various components and logic that may be employed to operate the robotic arms in the environment of FIG. 5.

The environment includes a conveyor belt 502 for moving objects to pick locations, including a first pick location 504 that is imaged by a first pick location sensor 506 (such as a camera) and serviced by a first pick location robotic arm 510 and a second pick location 532 that is imaged by a second pick location sensor 524 (such as a camera) and serviced by a second pick location robotic arm 528.

In the depicted embodiment, no upstream sensor is provided (although the depicted design does not necessarily exclude the possibility of using an upstream sensor). In the depicted embodiment, input data is provided by sensors mounted on or near each robotic arm. For example, a first pick location sensor 506 has a field of view 518 that includes the first pick location 504, and a second pick location sensor 524 has a field of view 526 that includes the second pick location 532. In some embodiments, the field of view 518 and the field of view 526 each provide a field of view that includes the portions of the conveyor belt 502 accessible to the respective robotic arms, and also an area upstream of the robotic arms that may or may not be accessible to the robotic arms. In this way, the sensors 506, 524 are capable of detecting objects as they move down the conveyor belt upstream of their respective robotic arms 510, 524 but before the robotic arms can reach them. This provides lead time to perform certain processing-intensive tasks, as discussed in more detail below.

The sensors 506, 524 may be any suitable type of sensor, such as a two-dimensional image camera or a three-dimensional image camera that produces images in three dimensions. In some embodiments, the sensor may include a distance or range sensor to determine a distance to a target objects.

According to exemplary embodiments, as the pile of objects on the conveyor belt 502 arrive in the field of view 518, 526 of each sensor, the pile is imaged and the system controller initially performs relatively complex, processing-intensive tasks. For example, the video feed from the sensors 506, 524 may be used to perform initial detection and segmentation of objects in the pile. It may also be used to classify the objects (determining a type of the object, determining which side of the object is presented to the sensor, etc.), determine an initial pose or orientation of the objects, and determine a degree to which each object is occluded by other objects.

To that end, data from each sensor may be provided to detection/segmentation logic 616 of a vision module 602 in a control computer 646. The detection/segmentation logic 616 may interact with a first machine learning construct (e.g., a first head of a neural network) of a multiheaded ML model 628.

A multiheaded AI model is a form of machine learning architecture that is designed to perform multiple tasks simultaneously and efficiently. The term “head” in this context refers to a module or a component of the neural network that is specialized for a specific task. In a multiheaded model, there are multiple such heads, each trained to handle different aspects of the data or problem at hand. This design allows the model to learn and predict various elements of the data in parallel, which can lead to more accurate and nuanced understanding and processing of complex datasets.

For instance, in image processing, one head might focus on identifying objects, another on determining their positions, and yet another on classifying the scenes. This is akin to having a team of experts where each member brings a unique skill set to the table, working together to solve a problem more comprehensively than any single expert could alone. The backbone of the model, which is common to all heads, extracts general features from the input data, which are then passed on to the individual heads for specialized processing.

The concept of multiheaded models is particularly prominent in the field of deep learning, where such architectures can significantly improve performance on tasks that require a multifaceted understanding of the input data. In essence, multiheaded AI models represent an advanced approach to machine learning, where the division of labor among multiple specialized components leads to more robust, flexible, and capable systems.

As an output, the first model may tag areas of the image as belonging to different data objects, each data object representing a different object on the conveyor belt 502. Once the objects are detected and segmented, subsequent data from the sensors 506, 524 may be used to perform less complex or intensive tasks. For example, the sensors may re-image the pile as it moves, and the locations, orientations, poses, and degree of occlusion of the objects in the pile may be updated based on tracking a difference between previous images of the pile and the images captured by the downstream sensors. Rather than making the initial determination of the locations, orientations, poses, occlusion, etc., at this stage the data from the sensors is only used to update the previously-determined locations, orientations, poses, occlusion, etc. as determined by previous processing. This is a significantly less time- and resource-intensive task, and can be done relatively quickly.

In other words, the data from the sensors is used to perform two different types of processing. The first type of processing performs object detection and segmentation and is relatively resource intensive. This processing will typically be done when new objects move into the sensor's field of view, often before the objects can be picked up by the sensor's respective robotic arm. The second type of processing simply updates the locations, poses, degrees of occlusion, etc. of previously-identified objects. In practice, the system will typically perform the first, resource intensive processing and use this information to identify one or more picks for the associated robotic arm. As the robotic arm executes on those picks, the pile is re-imaged to quickly update the locations of the target objects using the second, less-resource-intensive processing. If reasonable targets continue to exist for the robotic arm (e.g., picks having a score above a predetermined threshold value, as discussed below), the robotic arm may continue to execute on those picks. If no good targets exist, and/or at predetermined intervals, images of the pile that are upstream of the robotic arm may be processed with the first, resource-intensive processing so that new pick targets can be identified.

As the objects move down the conveyor belt 502, the first pick location robotic arm 510 and second pick location robotic arm 528 are configured to pick up objects at the first pick location 504 and 532, respectively, and move the picked objects to a destination location 512, such as a bin or a second conveyor belt. In moving the picked objects, the first pick location robotic arm 510 follows a robotic arm motion path 516 and the second pick location robotic arm 528 follows a motion path 530.

Preferably, each robotic arm will be provided with the location of its next pick in the time it takes to move along the motion path 516, 530 from the initial pick location 504, 532 to the destination location 512. By the time the robotic arm 510, 528 reaches the destination location 512, it needs to know the location of the next pick so that it can begin to move itself back along the motion path 516, 530 to position itself properly. This must happen very quickly-on the order of a few hundred milliseconds after the previous object is picked up. By first performing more time-consuming tasks, resource-intensive processing and then updating the information gleaned from this processing with more efficient processing performed based on the subsequent image data, picks can be selected more quickly (even when the pile of objects shifts due to previous picks or the motion of the conveyor belt 502).

However, obtaining usable imagery from the sensors 506, 524 is made more complicated by the fact that the robotic arm motion path 516 moves the first pick location robotic arm 510 into and out of the field of view 518 of the first pick location sensor 506, and the motion path 530 moves the second pick location robotic arm 528 into and out of the field of view 526 of the second pick location sensor 524. When the robotic arms are present in the fields of view of their respective sensors, they temporarily block at least part of the fields of view 518, 526. This creates obscured areas 534, 536 where the sensors 506, 524 cannot image the objects on the conveyor belt 502.

To address this problem, the control logic that acquires image data from the downstream sensors 506, 524 coordinates with the robotic arms 510, 528. To that end, each robotic system 612 performs a handshake 614 with the control computer 646 that is configured to coordinate and instruct the robotic systems 612. The handshake 614 defines a communication pathway that allows the robotic systems 612 to exchange positioning signals 620 with the control computer 646, and to receive location instructions 622 from the control computer 646. Each robotic system 612 is associated with a sensor 654. For example, as the robotic arms 510, 528 move along the motion paths 516, 530 and outside of the fields of view 518, 526 of their respective sensors, the control computer 646 interprets the positioning signals 620 to determine when the field of view 518, 526 is clear. Upon making that determination, the control computer 646 instructs the respective sensor to acquire the next image. This allows the sensors 654 to image the conveyor belt 502 as quickly as possible without being obscured by the robotic arms 510, 528, thus obtaining a usable image in the shortest amount of time possible. The sensor data 656 is then transmitted to the vision module 602 of the control computer 646.

More specifically, the image data from the sensors may be supplied to tracking logic 618, which makes use of other machine learning constructs (e.g., second, third, and fourth heads) of the multiheaded ML model 628. A second model head may be responsible for object classification; a third may be responsible for object pose; and a fourth may be responsible for object occlusion. These model heads may take the objects as identified by the first neural network, match them to the updated imagery from the downstream sensors 506, 524, and define parameters for the identified objects (such as the degree to which the object is occluded by other objects, a value representing the object's orientation, etc.).

Filter & sort logic 624 of an intelligence module 604 in the control computer 646 may then operate to select the next target object as a pick target for a robotic arm. The filter & sort logic 624 may first apply one or more filters to eliminate some objects from consideration that have parameters outside of predefined ranges or characteristics. One example of a filter is that any object that is occluded by more than a predetermined amount (which may be, for example, any amount of occlusion greater than zero) may be excluded from consideration. In another example, a filter may be applied to filter out any object that is in motion as the sensor 654 images the conveyor belt 502 (since it is more difficult to provide the robotic system 612 with a precise picking location for an object that is moving).

After the filters have been considered, any remaining candidate objects may be evaluated by sorting rules of the filter & sort logic 624. The sorting rules may rank the candidate objects to determine which object is in the best position or orientation to be grasped by the robotic arm. For instance, the sorting rules may rank objects that are oriented so as to present a larger surface that can be grasped, or a longer graspable axis, higher than objects that present less graspable surface or a shorter graspable axis.

Because the filter & sort logic 624 applies relatively simple filters and sorting rules, the filter & sort logic 624 can operate very quickly once the tracking logic 618 provides the parameters. The output of the filter & sort logic 624 may be an identifier of an object initially detected by the detection/segmentation logic 616 and tracked by the tracking logic 618, which may be sent to the robotic system 612 as a next pick target. The robotic system 612 may then attempt to pick the identified object. As the robotic system 612 moves, updated positioning signals 620 are sent to the control computer 646, and the process repeats.

In a system with multiple robotic systems 612 (e.g., multiple robotic arms 302 picking form a conveyor belt 502, as shown for example in FIG. 5), load balancing logic 644 may be applied so that the filtering and sorting rules are different for different robots along the line. For instance, the robotic arm at the end of the line may be configured to preferentially pick the object that has traveled the furthest downstream, so that objects are not missed. Upstream robots may be configured to preferentially pick up objects that are sitting on top of other objects, so that downstream robots will be presented with fewer occluded pick options.

Conventional systems typically rely entirely on a rules-based or ML-based approach to effect pick selections. In the present system, object detection and tracking are performed using an ML-based approach (with detection and different tracking tasks split between different heads of the multiheaded ML model 628 that can operate in parallel based on the same image data), and pick selection is done using the filtering and sorting rules of the filter & sort logic 624. Consequently, better pick candidates can be selected in a shorter amount of time, thus improving the throughput of the system while requiring less processing power.

The multiheaded ML model 628 is also trained using a unique process on a machine learning model build system 658. Conventionally, machine learning systems rely on labeled training data. This can be problematic because it may be difficult to secure a large amount of high-quality training data that has already been labeled (typically by a human). Moreover, existing models are usually general-purpose—for example, a classifier might be trained to look at a picture and identify arbitrary objects in the picture. In a pick-and-place scenario, however, this capability is typically more than is needed. A pick-and-place station is usually purpose-built to handle one particular type of object (e.g., pieces of chicken, a particular consumer item, etc.). Using a general-purpose model may unnecessarily slow down the pick-and-place process, as the model is built with significantly more complexity than necessary.

Exemplary embodiments provide techniques for training a special-purpose multiheaded ML model 628 using large amounts of high-quality synthetic training data 630. To generate the synthetic training data 630, one or more test products 652 (e.g., examples of the product expected to be picked in the pick-and-place system) may be obtained and scanned using a 3D scanner 650. The 3D scanner 650 produces one or more 3D scans 632 of the test product 652. The machine learning model build system 658 may then build a 3D model from the 3D scans 632. The 3D model may be a three-dimensional representation of the test product 652, and accordingly can be rotated and translated in 3D space. It can also be occluded by superimposing another 3D model on top of it, the superimposed model being at an arbitrary degree of rotation and/or viewing angle. The machine learning model build system 658 may use the 3D model to generate virtual images of the test product 652 at arbitrary angles, rotations, degree of occlusion, etc. The machine learning model build system 658 can apply other manipulations to the 3D model as well-warping surfaces, generating shadows, adding textures, adding distractors, deforming the model, performing physics simulations, etc.

The multiheaded ML model 628 may then be trained using these virtual images. The angle of the product, degree of rotation of the product, degree of occlusion of the product, etc. may be known because the machine learning model build system 658 specifically generated the virtual images with these parameters. Accordingly, these parameters can serve as labels for the training data, and the machine learning model can be trained to recognize these parameters in the images. Not only does this produce a large amount of training data, but the data is labeled more consistently and precisely than it might have been had it been labeled by a human.

In some embodiments, the 3D models may be split into multiples parts to generate multi-part assets 634. The individual parts can be manipulated, as described above, potentially in different ways for each part. The machine learning model build system 658 may adjust different parameters of the different pats in generating the images—for example, a chicken breast may be broken into a left side, a right side, and various perimeter parts. Each part may be augmented with different amounts of fat that has been trimmed to different extents.

In some embodiments, the virtual images may include multiple instances of the product in question in order to build a scene. The scene may optionally include additional information, such as a background representing a virtual conveyor belt, shadows caused by lighting conditions, a virtual representation of a gripper, etc.

The result of this process is a well-trained multiheaded ML model 628. However, the multiheaded ML model 628 may have been trained under specific simulated conditions. For example, the images may have been generated with certain color parameters (saturation, brightness, etc.) and under certain lighting conditions. These parameters define a calibration state 636. calibration logic 648 may use the calibration state 636 to attempt to bring the environment into alignment with the calibration state 636 to improve performance of the vision module 602. For example, the calibration logic 648 might provide, as an output on a display, a recommendation for optimal lighting that the pick-and-place operator should use to get the best performance. Alternatively or in addition, the calibration logic 648 might automatically adjust the lighting of the pick-and-place system to better align to the calibration state 636. In another example, the calibration logic 648 might adjust settings of the cameras or other sensors to achieve target characteristics for color, brightness, exposure, etc. that align to the synthetic training data 630.

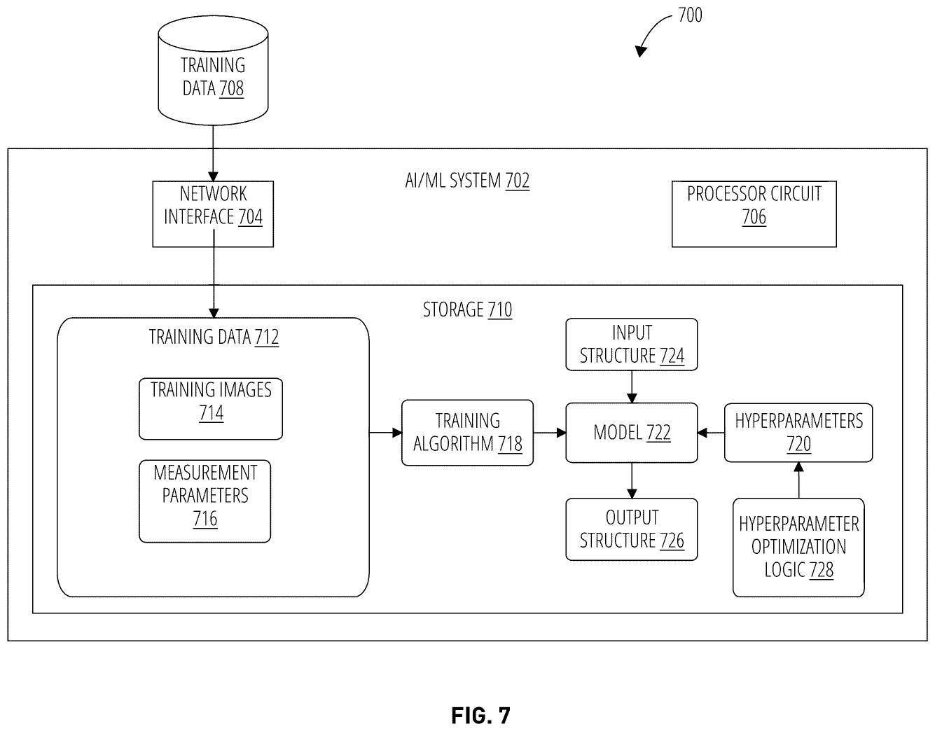

More details of machine learning systems are discussed below with reference to FIG. 7.

Fault warning logic 626 may continuously monitor the quality of data (e.g., image quality) from the sensors. The fault warning logic 626 may compare the quality of the imagery to an expected quality to determine if there is a deviation (e.g., due to lens occlusion, fogging, misalignment, etc.). If such a deviation is detected, the fault warning logic 626 may communicate the problem to an operator (e.g., on a display, through an error message, etc.). In some embodiments, the fault warning logic 626 may automatically pause operation of the conveyor belt 502 until the problem has been addressed. In some embodiments, the fault warning logic 626 may cooperate with data logging/analysis logic 640 so that a problem only causes the pick-and-place environment to pause operation if certain metrics (e.g., throughput, percentage of missed picks, etc.) drops below a predetermined threshold while a problem with a sensor exists.

Further improvements in throughput and efficiency can be achieved using data logging/analysis logic 640 with results visualized on an analytics UI 638. A sensor 654 on the soft gripper 606 may provide output signals describing grip quality as the soft gripper 606 grasps an object. These signals may be interpreted by grasp detection logic 610 to determine whether a pick was successfully executed. Information about the quality of the grip (e.g., whether the grip was successful, force applied, etc.) may be paired with the information used to select the target object for picking (e.g., the image data used by the tracking logic 618, the values for the parameters relating to rotation, occlusion, etc. as applied by the intelligence module 604, the filtering and sorting rules and parameter values applied by the filter & sort logic 624, etc.) Any or all of this information may be displayed on an analytics UI 638. The analytics UI 638 may also display overall system values, such as throughput, percentage of missed picks, etc.

In some embodiments, the analytics UI 638 may allow a user to adjust certain parameters, such as the filtering and sorting rules and parameters applied by the filter & sort logic 624, parameters applied by the load balancing logic 644, etc., in order to see how these changes would affect which object is selected as the next pick. In some embodiments, the adjusted parameters may be applied in a physics simulation that creates a simulated pile of product and carries out simulated picks using the adjusted parameters. The analytics UI 638 may display overall system values for the simulation so that these values can be compared between different simulations and to the actual values that were achieved. This allows a user to select values for the parameters that optimize system performance.

Exemplary embodiments may make use of artificial intelligence/machine learning (AI/ML).

FIG. 7 depicts an AI/ML environment 700 suitable for use with exemplary embodiments. FIG. 7 depicts a particular AI/ML environment 700 and is discussed in connection with neural networks. However, other AI/ML systems also exist, and one of ordinary skill in the art will recognize that AI/ML environments other than the one depicted may be implemented using any suitable technology.

The AI/ML environment 700 may include an AI/ML system 702, such as a computing device that applies an AI/ML algorithm to learn relationships between image data and the above-noted parameters (e.g., rotation, degree of occlusion, etc.).

The AI/ML system 702 may make use of training data 708, such as the synthetic training data 630 discussed above. The training data 708 may include training images 714 of individual objects or scenes including multiple objects and/or other image details such as backgrounds, textures, shadows, etc. In some cases, the training data 708 may include pre-existing labeled data from databases, libraries, repositories, etc. The training data 708 may be collocated with the AI/ML system 702 (e.g., stored in a storage 710 of the AI/ML system 702), may be remote from the AI/ML system 702 and accessed via a network interface 704, or may be a combination of local and remote data. Each unit of training data 708 may be labeled with measurement parameters 716 (e.g., by associating the image with metadata or information in a database).

As noted above, the AI/ML system 702 may include a storage 710, which may include a hard drive, solid state storage, and/or random access memory.

The training data 712 may be applied to train a model 722. Depending on the particular application, different types of models 722 may be suitable for use. For instance, in the depicted example, an artificial neural network (ANN) or a convolutional neural network (CNN) may be particularly well-suited to learning associations the training images 714 and the measurement parameters 716. The model 722 may be a multiheaded ML model 628. Other types of models 722, or non-model-based systems, may also be well-suited to the tasks described herein, depending on the designers goals, the resources available, the amount of input data available, etc.

Any suitable training algorithm 718 may be used to train the model 722. Nonetheless, the example depicted in FIG. 7 may be particularly well-suited to a supervised training algorithm. For a supervised training algorithm, the AI/ML system 702 may apply the training images 714 as input data, to which the resulting measurement parameters 716 may be mapped to learn associations between the inputs and the labels. In this case, the measurement parameters 716 may be used as a labels for the training images 714.

The training algorithm 718 may be applied using a processor circuit 706, which may include suitable hardware processing resources that operate on the logic and structures in the storage 710. The training algorithm 718 and/or the development of the trained model 722 may be at least partially dependent on model hyperparameters 720; in exemplary embodiments, the model hyperparameters 720 may be automatically selected based on hyperparameter optimization logic 728, which may include any known hyperparameter optimization techniques as appropriate to the model 722 selected and the training algorithm 718 to be used. Optionally, the model 722 may be re-trained over time.

In some embodiments, some of the training data 712 may be used to initially train the model 722, and some may be held back as a validation subset. The portion of the training data 712 not including the validation subset may be used to train the model 722, whereas the validation subset may be held back and used to test the trained model 722 to verify that the model 722 is able to generalize its predictions to new data.

Once the model 722 is trained, it may be applied (by the processor circuit 706) to new input data. The new input data may include unlabeled data stored in a data structure, such as data from the sensors 654. This input to the model 722 may be formatted according to a predefined input structure 724 mirroring the way that the training data 712 was provided to the model 722. The model 722 may generate an output structure 726 which may be, for example, a prediction of a measurement parameters 716 to be applied to the unlabeled input.

The above description pertains to a particular kind of AI/ML system 702, which applies supervised learning techniques given available training data with input/result pairs. However, the present invention is not limited to use with a specific AI/ML paradigm, and other types of AI/ML techniques may be used.

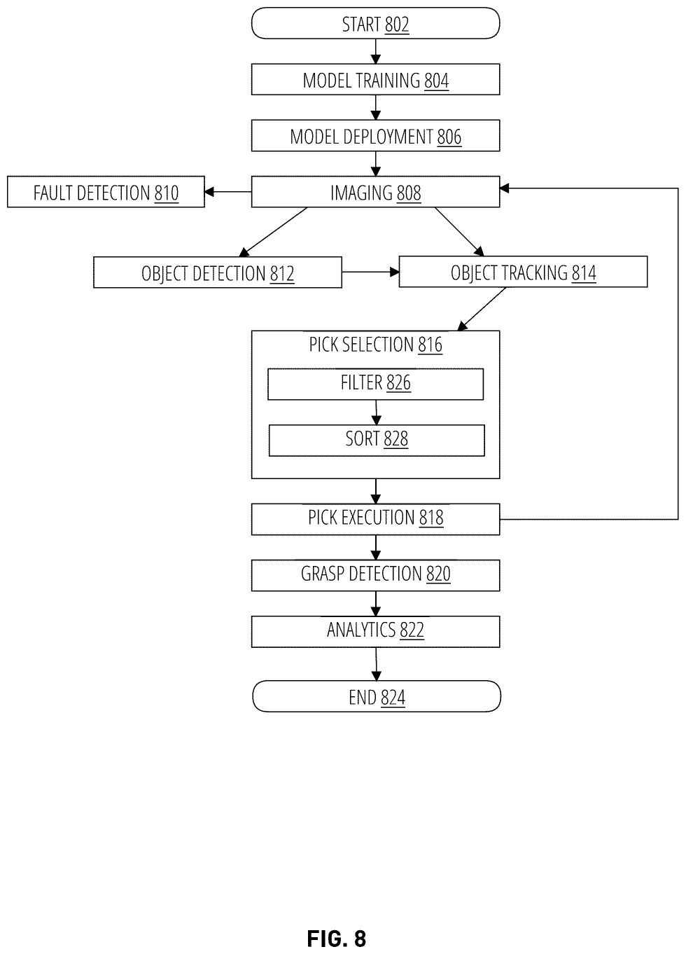

Next, FIG. 8 is a flowchart depicting exemplary logic for performing a computer-implemented pick-and-place method according to an exemplary embodiment. The logic may be embodied as instructions stored on a computer-readable medium configured to be executed by a processor. The logic may be implemented by a suitable computing system configured to perform the actions described below. Although the example routine depicts a particular sequence of operations, the sequence may be altered without departing from the scope of the present disclosure. For example, some of the operations depicted may be performed in parallel or in a different sequence that does not materially affect the function of the routine. In other examples, different components of an example device or system that implements the routine may perform functions at substantially the same time or in a specific sequence.

Moreover, although FIG. 8 depicts each of the logical blocks as being part of a single method (and it is contemplated that these blocks may be used together to achieve synergistic effects), it is also contemplated that the steps may be used individually or in subsets; technical advantages are realized from each logical block and they can be combined synergistically in any combination unless otherwise noted. By way of non-limiting example:
The model training 804 block may be used to train a machine learning model for use with the pick and place system, where the machine learning model can feed information to the object detection 812 block and the object tracking 814 block. The model training 804 can further be informed or retrained using the analytics 822 block and/or the grasp detection 820 block. This is not strictly necessary, however, and a model trained with synthetic training data as in the model training 804 block can be used for a variety of different purposes in many different types of robotic pick-and-place systems and in other applications.
The fault detection block 810 may be used to detect problems with the vision system used to perform the imaging 808, object detection 812, and/or object tracking 814, but may be more broadly applicable to other types of vision systems used in robotic pick-and-place systems and in other contexts.
The object detection 812 block and/or object tracking 814 block can be used to detect and track objects for pick selection 816, grasp detection 820, and for use by the model training 804 and/or analytics 822. They can also be used in other contexts to track objects visible to a sensor.
The pick selection 816 block that applies filter rules 826 and/or sorting rules 828 can achieve very high throughput when coupled with a machine learning model for object detection 812 and/or object tracking 814, but can be used to select picks in robotic pick-and-place systems that do not rely on machine learning, as well. To that end, the pick selection 816 block may be used with or without a model generated from the model training 804. Furthermore, the filter rules 826 and/or sorting rules 828 can be used to track analytics 822 and may be adjusted through an analytics interface, though this is not required.
The pick execution 818 block may be used with a machine learning model for object detection 812 and/or object tracking 814, or may be used to select picks when objects are not so tracked. Similarly, the pick execution 818 block may be used with the filter rules 826 and/or sorting rules 828, or may be used without applying such rules.
The grasp detection 820 block may be used to inform the analytics 822 block, but may be used in other contexts as well. The grasp detection 820 block may be used to inform and/or retrain the model built in the model training 804, or for other purposes.
The analytics 822 block, as discussed above, may be informed by various other blocks and may be used to adjust the filter rules 826, the sorting rules 828, the model training 804, etc. It can also be used independently to generate and display analytical information for a robotic pick and place system in other contexts and in other applications.

Turning to the details of the depicted method, according to some examples the method begins at start block 802. Prior to or after starting the method at start block 802, a robotic pick-and-place system may be provisioned as depicted in FIG. 5, with any number of robotic arms and destination location 512 (e.g., different destination locations 512 may be provided for different types of products). Each robotic arm may be provided with a gripper including one or more soft robotic actuators.

According to some examples, the method includes modeling training at model training 804. The model may be a multi-headed machine learning model.

According to some examples, the method includes modeling deployment at model deployment 806. Once the machine learning model is trained (e.g., by machine learning model build system 658) in block 804, it may be necessary to integrate the model into the robotic pick-and-place system. Among other actions, this may involve identifying the model's calibration state 636 from the lighting specification used to generate the model and attempting to match the lighting conditions in the vicinity of the robotic pick-and-place station to the calibration state 636.

According to some examples, the method includes imaging at block 808. The imaging may be performed by the sensors of the robotic pick and place station. The sensors may be capable of capturing images at an imaging rate, such as 15 frames per second. In some embodiments, each of the frames is used to perform object tracking 814, whereas only certain frames (e.g., the first frame captured after the robotic arm moves out of the sensor's field of view) are used to perform object detection 812.

According to some examples, the method includes fault detection at block 810. The fault detection logic may be particularly useful when working in certain environments, such as food picking, in which material may splatter on the lens of the sensor. Other applications may also involve situations in which the lens can become occluded. The pick and place system may be configured to alert operators that the lens is occluded by detecting an amount of an image that is obscured, potentially across multiple frames. The threshold at which this warning is triggered may be user-configurable at a time of set-up, and may be editable in production through a user interface.

According to some examples, the method includes object detection at object detection 812 block. According to some examples, the method includes object tracking at object tracking 814 block.

According to some examples, the method includes pick selection at pick selection 816. Pick selection may involve the application of filter rules 826 and/or sorting rules 828.

According to some examples, the method includes pick execution 818. When a pick is identified during pick selection 816, information about the pick (e.g., a predicted location where the target object is expected to be located, target grasping points at which the gripper's actuators should attempt to grasp the target, etc.) may be provided to the robotic arm and used to direct the robotic arm to pick up the target object.

In some embodiments, pick execution 818 may involve calculating and applying a vision-based variable opening amount for the robotic gripper. This may allow the gripper to address variability in size, shape, and presentation of objects. For non-singulated picking (e.g., picking from a chaotic pile where products are not guaranteed to be in a particular configuration or orientation, or to avoid touching adjacent products), using a vision-based variable opening amount may avoid finger collision with adjacent items or accidentally picking multiple objects. To that end, the vision system may compute a precise width of each item in the field of view of the sensor, and may set an opening amount for each individual to limit an amount of disturbance of surrounding products and/or product damage.

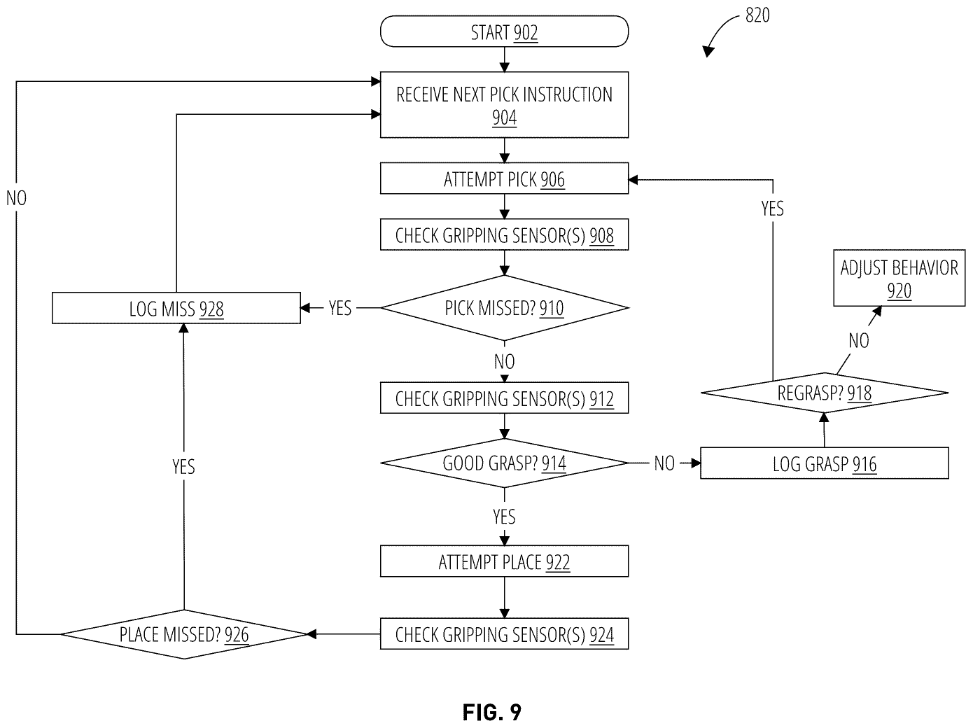

According to some examples, the method includes grasp detection 820. As the pick is attempted, sensors embedded in the actuators may be engaged and provide data indicative of a quality of the gripper's grasp. This may occur, for example, immediately after a pick is attempted on a target object, after the target object is lifted from the conveyor, as the target object is moved to the destination location, and/or just before the target object is released at the destination location. Grasp detection is described in more detail in connection with FIG. 9.

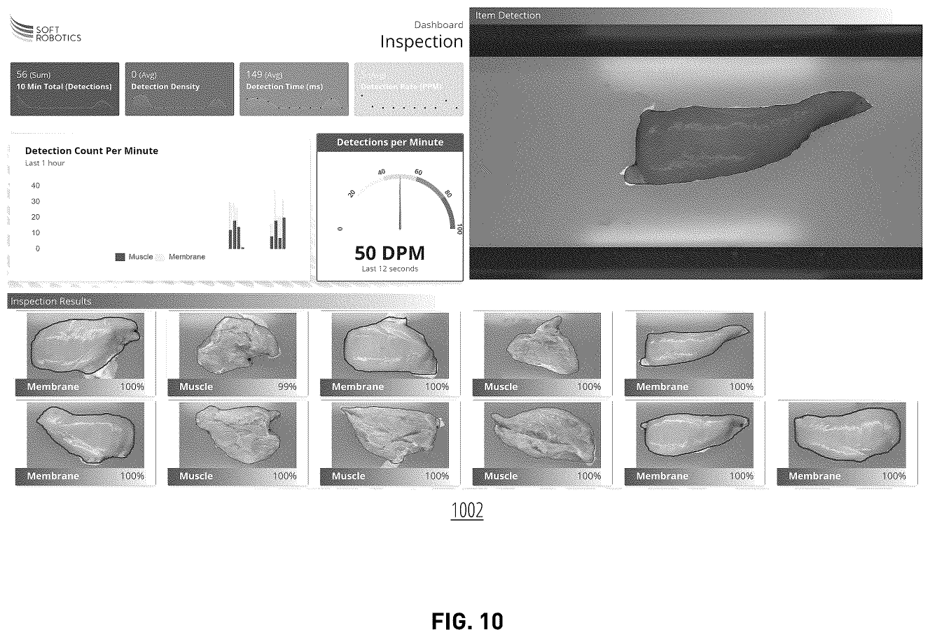

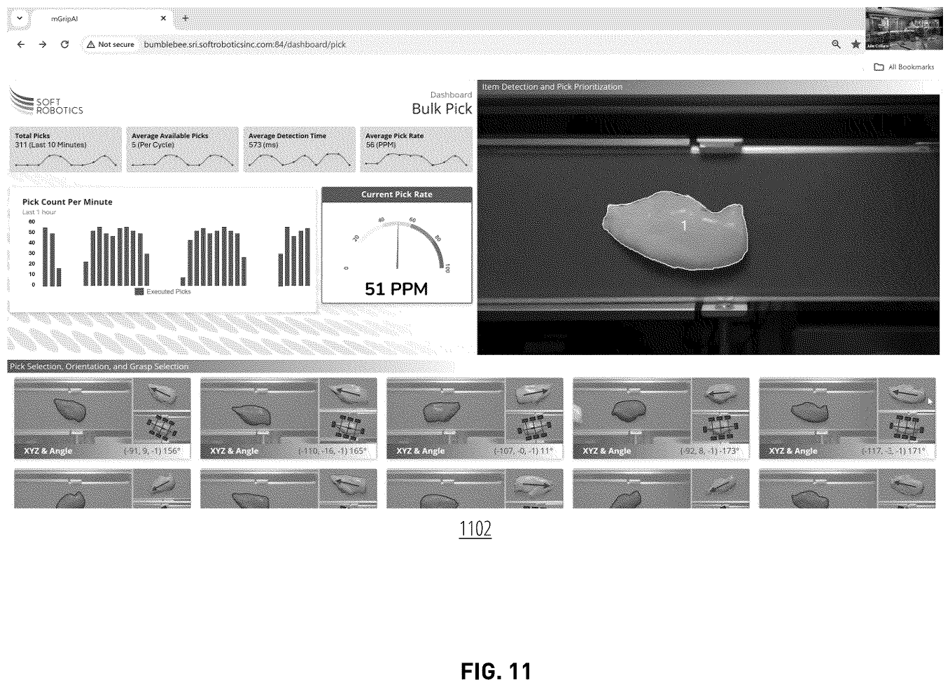

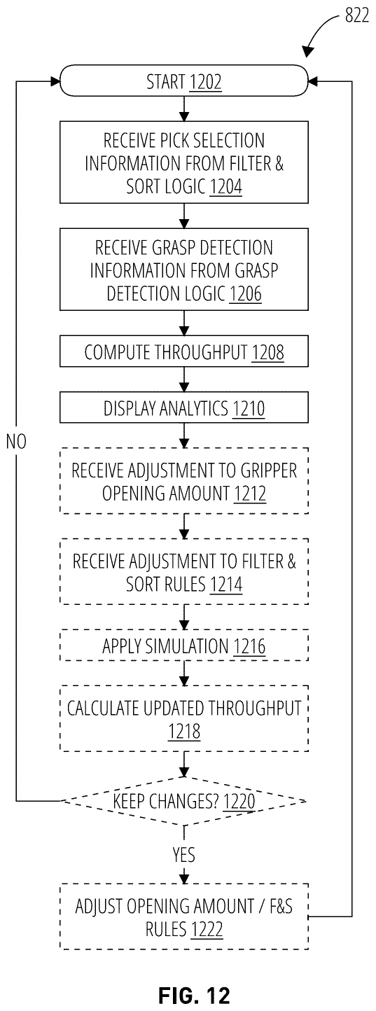

According to some examples, the method includes performing analytics 822. This may involve computing a throughput for the robotic pick and place system, as well as computing and displaying other relevant values on an analytics user interface. An example of an analytics user interface is shown in FIG. 10-FIG. 11, and the analytics 822 process is depicted in more detail in FIG. 12.

After all picks have been executed, processing may proceed to done block 824 and terminate.

FIG. 9 is a flowchart depicting exemplary logic for detecting grip quality according to an exemplary embodiment. The logic may be embodied as instructions stored on a computer-readable medium configured to be executed by a processor. The logic may be implemented by a suitable computing system configured to perform the actions described below. Although FIG. 9 depicts particular logical blocks arranged in a particular order, one of ordinary skill in the art will understand that the blocks may be performed in a different order, some blocks may be performed in parallel, some blocks may be omitted, and/or some additional procedures may be added.

The method may begin at start block 902. Start block 902 may operate, for instance, at system startup or when a grip quality detection method is launched by a user of the system.

The system may receive a next pick instruction at block 904. For example, the above-described machine learning model and filter and sort logic may operate as described above to select a next pick target and transmit a target pick location to a robotic arm.

At block 906, the pick identified in block 904 may be attempted. For instance, the robotic arm may move to the location identified in the pick instruction and attempt to close the gripper around the target object.

Next, gripping sensor(s) may be checked at block 908 to evaluate whether the grip was successfully executed. For instance, the gripper may include pressure or other sensors that can detect whether an object is secured by the gripper. In some embodiments, the gripping sensor(s) may include the above-described imaging sensors, and the images may be consulted to determine if the object was successfully grasped. Other types of grasp detection known in the art may also be employed. At block 908, the system may make an initial detection of whether a grip was successfully effected; it may not necessarily determine whether the target object was successfully delivered to a target location (although this is also a possible way of detecting whether a grip was successful).

At block 910, the system determines if the gripper missed the pick attempted at block 906, based on the output of the sensor(s) from block 908. For example, if the pressure sensors indicate that an object is not gripped by the gripper, or if camera data shows that the object is not within or touched by the gripper's fingers, then at block 910 it may be determined that the grip failed. Otherwise, it may be determined that the grip initially succeeded.

If the grip was determined to have failed at block 910, then processing may proceed to block 928 and the system may log, in an analytics log, that the grip failed. The system may add other information to the grip log as well, such as information output by the machine learning construct and/or the filter and sort logic (e.g., the pose of the object, the object's location, the object's classification, a degree of occlusion, a degree of rotation, etc.). A timestamp for the missed pick may also be logged in order to determine system throughput.

If the grip was initially successful, then processing may proceed to block 912, where gripping sensor(s) may be checked to determine whether the object remains gripped as the robotic arm moves the object towards the target location where it will be placed. This block may employ the same sensors employed at block 908, or different sensors.

At block 914, the system may attempt to determine a quality of the grasp. For example, if the gripper employs pressure sensors on one or more fingers, the pressure sensors may be consulted to determine an amount of force that is being used to grasp the target object and/or how many fingers are in contact with the object. Similarly, image data from the sensors may be used to determine how much of the target object is encompassed by the gripper's fingers, whether the object shifts as it is being translated, etc. This information may be used to calculate a grip score indicating a quality of the grasp.

If the system determines, at decision block 914, that the robotic arm has not secured a good grasp (e.g., if the above-described grip score is below a predetermined threshold amount), then at block 916 the system may log the grasp and its quality in the aforementioned analytics log. As before, the system may store relevant parameters describing the target object and/or a timestamp in the analytics log.

At block 918, the system may determine whether it should attempt to regrasp the target object. The determination may be made based on the grip score. For example, a very low grip score (below a second predetermined threshold) may indicate that the gripper is unlikely to maintain its grip on the target object as it moves the target object to its target location. Accordingly, processing may return to block 906, and the system may attempt to make a new pick (which may be a new pick on the same target object, or may involve selecting a new object to be picked).

Alternatively, if the system determines at block 918 that a regrasp should not be attempted (e.g., the score is above the second predetermined threshold, indicating that the gripper has a relatively poor grasp but one that is likely to be maintainable as the target object is moved to the target location), then processing may optionally proceed to block 920 where a behavior of the robotic arm may be adjusted. For instance, the robotic arm may be instructed to reduce its speed or change its course to reduce the motion forces on the target object as it is moved to the target location. This may help the robotic gripper to maintain its grasp, even when the grasp is relatively weak. Processing may then proceed back to block 922.

Blocks 912-920 may be repeated at predetermined intervals as the object is moved towards the target location.

At block 922, which may be reached after block 920 if the system has a relatively poor grasp but still evaluates that an attempt to place the object at the target location can be made or after block 914 if the system determines that it has secured a good grasp, the system may attempt to place the target object at a target location. For instance, the target location may be inside of a container, on another conveyor belt that takes the target object to a predetermined location, an inspection station, etc. The system may attempt to move the target object to the target location, and then instruct the gripper to release its grasp.

At block 924, the system may check the gripping sensors to determine if the target object was successfully placed at the target location. The sensors may be the same as, or different than, those used in blocks 908 and 912. For example, a camera, scale, or other type of sensor at the target location may be used to determine if the object was successfully delivered to the target location.

If the system determines, at block 926, that the target object was not successfully delivered to the target location, then processing ay proceed to block 928 and the miss may be logged in the analytics log as previously described. Alternatively, if the object was successfully placed, the success may be logged in the analytics log in a manner similar to the one previously described (though with an indication that the pick was successful, rather than failed). The other information such as the timestamp and object parameters may also be logged.

Processing may then revert to block 904, and a new pick may be attempted.

FIG. 10 and FIG. 11 depict exemplary user interfaces 1002, 1102, suitable for use with exemplary embodiments. FIG. 12, meanwhile, is a flowchart describing techniques for generating and updating such user interfaces. FIG. 12 will therefore be described with reference to FIGS. 10 and 11.

FIG. 12 is a flowchart depicting exemplary logic for performing a computer-implemented method according to an exemplary embodiment. The logic may be embodied as instructions stored on a computer-readable medium configured to be executed by a processor. The logic may be implemented by a suitable computing system configured to perform the actions described below. Although FIG. 12 depicts particular logical blocks arranged in a particular order, one of ordinary skill in the art will understand that the blocks may be performed in a different order, some blocks may be performed in parallel, some blocks may be omitted, and/or some additional procedures may be added.

The method may start at start block 1202, which may be executed at device startup or in response to an instruction from a user to generate an analytics user interface, among other possibilities.

At block 1204, the system may receive pick selection information from filter & sort logic (as discussed above). For example, the filter and sort logic may identify, using an object identifier as assigned by object detection logic, a particular object that was considered for picking. The filter and sort logic may have filtered the object out of consideration (e.g., because the object was occluded or in motion). For objects that were not filtered out, the filter and sort logic may have assigned the object a pick score. The object with the highest pick score may have been selected as the next pick target. Any or all of this information may be received at block 1204.

At block 1206, the system may receive grasp information from grasp detection logic. For example, the procedure for grasp detection 820 as shown in FIG. 9 may determine when a graps is missed and, when a grasp is successful, a quality of the grasp. This information may be stored in an analytics log, which may be received at block 1206.

At block 1208, the system may use the information obtained in block 1206 to compute a system throughput. The system throughput may represent the number, rate, percentage, or some similar metric indicating a frequency of successful picks or a ratio of successful picks to the total number of picks attempted.

At block 1210, the system may display analytics, such as the throughput computed in block 1208 and information obtained in block 1204. The analytics may be displayed in a user interface that may be updated as picks are attempted. Information may be calculated from the information collected, and may be displayed in the interface. For instance, FIG. 10 depicts an example of an interface that shows a view of the sensor associated with a particular robotic arm (upper right corner), statistics related to the detection process, such as the average amount of time required to perform a detection with the object detection logic, a rate of detections performed (e.g., per minute), a total number of detections performed in a predetermined interval (e.g., 5, 10, 15, 30, or 60 minutes), etc. In this example, the bottom of the interface shows the output of the object detection logic, which may include a representation of each object detected and, if the object is classified (e.g., according to properties of the object such as the amount of fat on a piece of chicken), results of the classification.

FIG. 11 provides another example of an analytics interface. Once again, the interface includes a view from the sensor and analytical information (in this case, information related to pick success, such as the rate of picks attempted, percentage and/or rate of successful picks, the number of potential picks that were provided to the sorting logic after being filtered by the filter logic, etc.). In this example, the bottom of the interface includes attempted grasp information, including a representation of each target object for which a grasp was considered, and the locations on the target object at which the system attempted to place the gripper fingers. It also includes orientation information, such as the location, pose, rotation, etc. of the object.

In any of the analytics interfaces, other information may also be displayed (such as the score assigned to the target object by the sorting logic, whether the object was filtered out by the filter logic, quality of the grasp if a grasp was attempted, etc.).

Optionally, the information in the analytics interface may be used to test or make changes to the operation of the pick-and-place system. For example, at block 1212, an adjustment to the gripper opening amount may be provided. For instance, a user may indicate, in analytics interface, that the gripper opening amount should be adjusted in one direction or another by an absolute amount or a percentage. At block 1214, the system may receive, through the interface, a user-defined adjustment to the filter and sort rules (e.g., adjusting the weights applied by the sorting rules, the threshold degrees of occlusion or adjacency that would cause the filter rules to filter out an object from consideration, etc.)

Based on the adjustments made in blocks 1212 and 1214, the system may optionally simulate an effect of the changes using historical data. For example, the system may adjust the filter and sort rules, and re-run recent picks to see if different target objects would have been selected given the same data from the sensors. If different picks would have been selected, the system may optionally simulate the new picks using (e.g.) a three-dimensional model of the gripper and a three-dimensional model of the scene captured by the sensors. Alternatively or in addition, the system may compare the new proposed picks to historical data to estimate a likelihood that the new pick would be successful. The system may also simulate the effect of an adjusted gripper opening amount, such as by determining if the gripper would interfere with nearby objects (when applying a larger opening amount, for example), or whether the gripper would not open to a sufficient degree to secure a good grasp (when applying a smaller opening amount, for example), or vice versa.

Based on the results of the simulation, the system may optionally calculate an updated throughput at block 1218. For instance, the system may determine, over a predetermined period of time or for a predetermined number of picks, a rate or frequency of successful picks. This information may be displayed alongside the actual, historical information, for comparison purposes.

The system may present an confirmation option allowing the user to confirm whether the changes should be kept or discarded at decision block 1220. If the changes are discarded, then processing may revert to start block 1202 and processing may proceed with the next pick. Alternatively, if the changes are accepted at decision block 1220, then processing may proceed to block 1222 where the changes may be implemented in the system. Processing may then revert to block 1202 as discussed above.

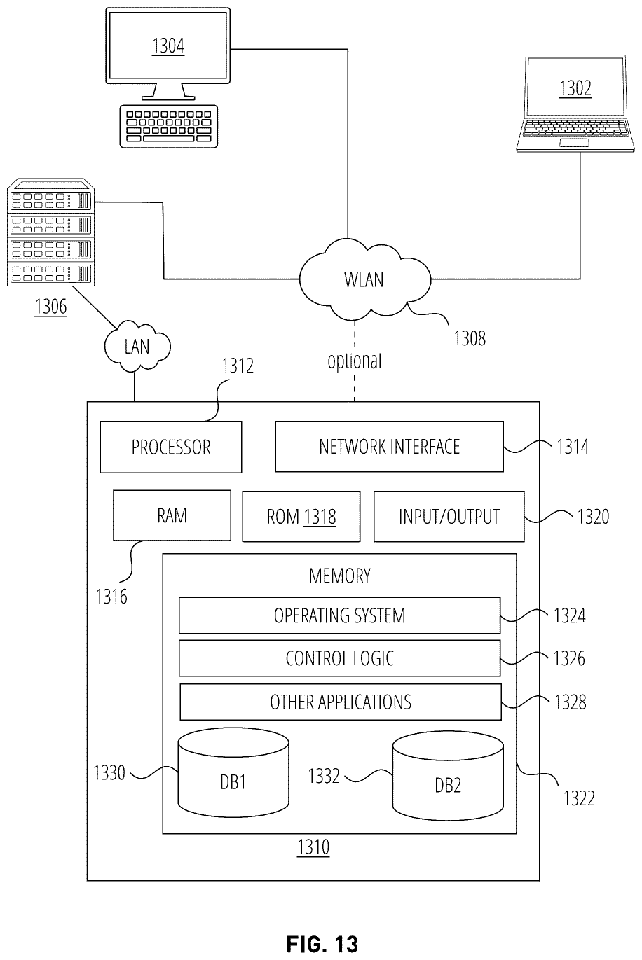

FIG. 13 illustrates one example of a system architecture and data processing device that may be used to implement one or more illustrative aspects described herein in a standalone and/or networked environment. Various network nodes, such as the data server 1310, web server 1306, computer 1304, and laptop 1302 may be interconnected via a wide area network 1308 (WAN), such as the internet. Other networks may also or alternatively be used, including private intranets, corporate networks, LANs, metropolitan area networks (MANs) wireless networks, personal networks (PANs), and the like. Network 1308 is for illustration purposes and may be replaced with fewer or additional computer networks. A local area network (LAN) may have one or more of any known LAN topology and may use one or more of a variety of different protocols, such as ethernet. Devices data server 1310, web server 1306, computer 1304, laptop 1302 and other devices (not shown) may be connected to one or more of the networks via twisted pair wires, coaxial cable, fiber optics, radio waves or other communication media.

Computer software, hardware, and networks may be utilized in a variety of different system environments, including standalone, networked, remote-access (aka, remote desktop), virtualized, and/or cloud-based environments, among others.

The term “network” as used herein and depicted in the drawings refers not only to systems in which remote storage devices are coupled together via one or more communication paths, but also to stand-alone devices that may be coupled, from time to time, to such systems that have storage capability. Consequently, the term “network” includes not only a “physical network” but also a “content network,” which is comprised of the data—attributable to a single entity—which resides across all physical networks.

The components may include data server 1310, web server 1306, and client computer 1304, laptop 1302. Data server 1310 provides overall access, control and administration of databases and control software for performing one or more illustrative aspects described herein. Data serverdata server 1310 may be connected to web server 1306 through which users interact with and obtain data as requested. Alternatively, data server 1310 may act as a web server itself and be directly connected to the internet. Data server 1310 may be connected to web server 1306 through the network 1308 (e.g., the internet), via direct or indirect connection, or via some other network. Users may interact with the data server 1310 using remote computer 1304, laptop 1302, e.g., using a web browser to connect to the data server 1310 via one or more externally exposed web sites hosted by web server 1306. Client computer 1304, laptop 1302 may be used in concert with data server 1310 to access data stored therein, or may be used for other purposes. For example, from client computer 1304, a user may access web server 1306 using an internet browser, as is known in the art, or by executing a software application that communicates with web server 1306 and/or data server 1310 over a computer network (such as the internet).

Servers and applications may be combined on the same physical machines, and retain separate virtual or logical addresses, or may reside on separate physical machines. FIG. 13 illustrates just one example of a network architecture that may be used, and those of skill in the art will appreciate that the specific network architecture and data processing devices used may vary, and are secondary to the functionality that they provide, as further described herein. For example, services provided by web server 1306 and data server 1310 may be combined on a single server.

Each component data server 1310, web server 1306, computer 1304, laptop 1302 may be any type of known computer, server, or data processing device. Data server 1310, e.g., may include a processor 1312 controlling overall operation of the data server 1310. Data server 1310 may further include RAM 1316, ROM 1318, network interface 1314, input/output interfaces 1320 (e.g., keyboard, mouse, display, printer, etc.), and memory 1322. Input/output interfaces 1320 may include a variety of interface units and drives for reading, writing, displaying, and/or printing data or files. Memory 1322 may further store operating system software 1324 for controlling overall operation of the data server 1310, control logic 1326 for instructing data server 1310 to perform aspects described herein, and other application software 1328 providing secondary, support, and/or other functionality which may or may not be used in conjunction with aspects described herein. The control logic may also be referred to herein as the data server software control logic 1326. Functionality of the data server software may refer to operations or decisions made automatically based on rules coded into the control logic, made manually by a user providing input into the system, and/or a combination of automatic processing based on user input (e.g., queries, data updates, etc.).

Memory 1122 may also store data used in performance of one or more aspects described herein, including a first database 1332 and a second database 1330. In some embodiments, the first database may include the second database (e.g., as a separate table, report, etc.). That is, the information can be stored in a single database, or separated into different logical, virtual, or physical databases, depending on system design. Web server 1306, computer 1304, laptop 1302 may have similar or different architecture as described with respect to data server 1310. Those of skill in the art will appreciate that the functionality of data server 1310 (or web server 1306, computer 1304, laptop 1302) as described herein may be spread across multiple data processing devices, for example, to distribute processing load across multiple computers, to segregate transactions based on geographic location, user access level, quality of service (QOS), etc.

One or more aspects may be embodied in computer-usable or readable data and/or computer-executable instructions, such as in one or more program modules, executed by one or more computers or other devices as described herein. Generally, program modules include routines, programs, objects, components, data structures, etc. that perform particular tasks or implement particular abstract data types when executed by a processor in a computer or other device. The modules may be written in a source code programming language that is subsequently compiled for execution, or may be written in a scripting language such as (but not limited to) HTML or XML. The computer executable instructions may be stored on a computer readable medium such as a nonvolatile storage device. Any suitable computer readable storage media may be utilized, including hard disks, CD-ROMs, optical storage devices, magnetic storage devices, and/or any combination thereof. In addition, various transmission (non-storage) media representing data or events as described herein may be transferred between a source and a destination in the form of electromagnetic waves traveling through signal-conducting media such as metal wires, optical fibers, and/or wireless transmission media (e.g., air and/or space). various aspects described herein may be embodied as a method, a data processing system, or a computer program product. Therefore, various functionalities may be embodied in whole or in part in software, firmware and/or hardware or hardware equivalents such as integrated circuits, field programmable gate arrays (FPGA), and the like. Particular data structures may be used to more effectively implement one or more aspects described herein, and such data structures are contemplated within the scope of computer executable instructions and computer-usable data described herein.

The components and features of the devices described above may be implemented using any combination of discrete circuitry, application specific integrated circuits (ASICs), logic gates and/or single chip architectures. Further, the features of the devices may be implemented using microcontrollers, programmable logic arrays and/or microprocessors or any combination of the foregoing where suitably appropriate. It is noted that hardware, firmware and/or software elements may be collectively or individually referred to herein as “logic” or “circuit.”

It will be appreciated that the exemplary devices shown in the block diagrams described above may represent one functionally descriptive example of many potential implementations. Accordingly, division, omission or inclusion of block functions depicted in the accompanying figures does not infer that the hardware components, circuits, software and/or elements for implementing these functions would be necessarily be divided, omitted, or included in embodiments.

At least one computer-readable storage medium may include instructions that, when executed, cause a system to perform any of the computer-implemented methods described herein.

Some embodiments may be described using the expression “one embodiment” or “an embodiment” along with their derivatives. These terms mean that a particular feature, structure, or characteristic described in connection with the embodiment is included in at least one embodiment. The appearances of the phrase “in one embodiment” in various places in the specification are not necessarily all referring to the same embodiment. Moreover, unless otherwise noted the features described above are recognized to be usable together in any combination. Thus, any features discussed separately may be employed in combination with each other unless it is noted that the features are incompatible with each other.

With general reference to notations and nomenclature used herein, the detailed descriptions herein may be presented in terms of program procedures executed on a computer or network of computers. These procedural descriptions and representations are used by those skilled in the art to most effectively convey the substance of their work to others skilled in the art.

A procedure is here, and generally, conceived to be a self-consistent sequence of operations leading to a desired result. These operations are those requiring physical manipulations of physical quantities. Usually, though not necessarily, these quantities take the form of electrical, magnetic or optical signals capable of being stored, transferred, combined, compared, and otherwise manipulated. It proves convenient at times, principally for reasons of common usage, to refer to these signals as bits, values, elements, symbols, characters, terms, numbers, or the like. It should be noted, however, that all of these and similar terms are to be associated with the appropriate physical quantities and are merely convenient labels applied to those quantities.

Further, the manipulations performed are often referred to in terms, such as adding or comparing, which are commonly associated with mental operations performed by a human operator. No such capability of a human operator is necessary, or desirable in most cases, in any of the operations described herein, which form part of one or more embodiments. Rather, the operations are machine operations. Useful machines for performing operations of various embodiments include general purpose digital computers or similar devices.

Some embodiments may be described using the expression “coupled” and “connected” along with their derivatives. These terms are not necessarily intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

Various embodiments also relate to apparatus or systems for performing these operations. This apparatus may be specially constructed for the required purpose or it may comprise a general purpose computer as selectively activated or reconfigured by a computer program stored in the computer. The procedures presented herein are not inherently related to a particular computer or other apparatus. Various general purpose machines may be used with programs written in accordance with the teachings herein, or it may prove convenient to construct more specialized apparatus to perform the required method steps. The required structure for a variety of these machines will appear from the description given.

It is emphasized that the Abstract of the Disclosure is provided to allow a reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims.

What is claimed is:

1. A method for generating and displaying analytics for a robotic pick and place system, the method comprising:
displaying a user interface on a display associated with the robotic pick and place system, the user interface comprising a user interface element depicting a throughput of the robotic pick and place system;
executing one or more picks with the robotic pick and place system; and
updating the user interface based on results of the one or more picks.

2. The method of claim 1, wherein the throughput is an instantaneous throughput at a time of one of the one or more picks.

3. The method of claim 1, wherein the throughput is an average throughput over a predetermined time interval.

4. The method of claim 1, wherein the interface further comprises a user interface element depicting a score output by one or more of filtering or sorting logic configured to provide information used to select a next pick for the pick and place station.

5. The method of claim 1, wherein the interface further comprises a user interface element depicting a number or a percent of missed picks over a predetermined time interval.

6. The method of claim 1, wherein the interface further comprises a user interface element depicting a number or a percent of missed placements over a predetermined time interval.

7. The method of claim 1, wherein the interface further comprises a user interface element depicting a grasp quality achieved by the pick and place system.

8. The method of claim 1, wherein the interface further comprises a user interface element depicting an overall equipment effectiveness value for the pick and place system.

9. The method of claim 1, wherein the interface further comprises a user interface element depicting an object segmentation for objects picked in the one or more picks.

10. The method of claim 9, wherein the user interface element depicting the object segmentation furthermore depicts at least one of an orientation or a size of the object.

11. A system comprising:
a robotic arm;
a conveyor for conveying objects to the robotic arm;
a sensor; and
a processor configured to perform the method of claim 1.

12. A non-transitory computer-readable storage medium, the computer-readable storage medium including instructions that when executed by a computer, cause the computer to:
display a user interface on a display associated with the robotic pick and place system, the user interface comprising a user interface element depicting a throughput of the robotic pick and place system;
execute one or more picks with the robotic pick and place system; and
update the user interface based on results of the one or more picks.

13. The computer-readable storage medium of claim 12, wherein the throughput is an instantaneous throughput at a time of one of the one or more picks.

14. The computer-readable storage medium of claim 12, wherein the throughput is an average throughput over a predetermined time interval.

15. The computer-readable storage medium of claim 12, wherein the interface further comprises a user interface element depict a score output by one or more of filtering or sorting logic configured to provide information used to select a next pick for the pick and place station.

16. The computer-readable storage medium of claim 12, wherein the interface further comprises a user interface element depict a number or a percent of missed picks over a predetermined time interval.

17. The computer-readable storage medium of claim 12, wherein the interface further comprises a user interface element depict a number or a percent of missed placements over a predetermined time interval.

18. The computer-readable storage medium of claim 12, wherein the interface further comprises a user interface element depict a grasp quality achieved by the pick and place system.

19. The computer-readable storage medium of claim 12, wherein the interface further comprises a user interface element depict an overall equipment effectiveness value for the pick and place system.

20. The computer-readable storage medium of claim 12, wherein the interface further comprises a user interface element depict an object segmentation for objects picked in the one or more picks.

21. The computer-readable storage medium of claim 20, wherein the user interface element depicting the object segmentation furthermore depicts at least one of an orientation or a size of the object.
